(19) United States
(12) Patent Application Publication
(10) Pub. No.: US 2010/0144888 A1
(43) Pub. Date: Jun. 10, 2010

(54) PESTICIDAL METHODS AND COMPOSITIONS FOR MODULATING GABA RECEPTORS

(75) Inventor: Steven M. BESSETTE, Brentwood, TN (US)

Correspondence Address: NIXON & VANDERHYE, PC, 901 NORTH GLEBE ROAD, 11TH FLOOR, ARLINGTON, VA, 22203, US

(73) Assignee: ECOSMART TECHNOLOGIES, INC., Alpharetta, GA (US)

(21) Appl. No.: 12/543,406

(22) Filed: Aug. 18, 2009

Related U.S. Application Data
(60) Provisional application No. 61/089,841, filed on Aug. 18, 2008.
(60) Provisional application No. 61/090,263, filed on Aug. 20, 2008.
(60) Provisional application No. 61/169,531, filed on Apr. 15, 2009.

(51) Int. Cl. A01N 31/08; A01N 35/06; A01P 17/00; A01P 7/04; A01P 7/02; A01P 5/00; A01P 3/00; A01P 15/00; A01P 19/00; A01N 31/04; A01N 31/02

(52) U.S. Cl. 514/690; 514/731; 514/729; 514/739

(57) ABSTRACT

Methods for using pesticidal compositions containing a pesticidally acceptable carrier, at least one GABA receptor modulator compound as a pesticidally active ingredient and optionally an additional compounds, such as a synergist, and methods for using same.

### CROSS REFERENCE TO RELATED APPLICATIONS

This application is related to and claims the benefit of U.S. Provisional Patent Application Ser. No. 61/089,841, filed Aug. 18, 2008; U.S. Provisional Patent Application Ser. No. 61/090,263, filed Aug. 20, 2008; and U.S. Provisional Patent Application Ser. No. 61/169,531, filed Apr. 15, 2009; the entire disclosures of which are incorporated herein by reference.

### FIELD OF THE INVENTION

The present invention relates to the field of GABA receptor structure and function. Certain exemplary embodiments relate to, without limitation, pesticidally-effective compositions and methods for using same as GABA receptor modulators or affector agents against pests.

### BACKGROUND OF THE INVENTION

Pests are annoying to humans for several reasons. Pests include pathogenic organisms which infest mammals and plants; some pests can spread disease as disease vectors. The pathogenic organisms that infest plants and cause economic loss of plant crops include fungi, insects, arachnids, gastropods, nematodes and the like. The pathogenic organisms that infest animals include ticks, mites, fleas, and mosquitoes. Other pests include cockroaches, termites and ants. These and other pests have annually cost humans billions of dollars in crop losses in the case of agricultural pests and in the expense of keeping them under control. For example, the losses caused by pests in agricultural environments include decreased crop yield, reduced crop quality, and increased harvesting costs. In household scenarios, insect pests may act as vectors for diseases and allergic matter.

Nematodes, which are unsegmented roundworms with elongated, fusiform, or saclike bodies covered with a cuticle, are pests that are virtually ubiquitous in nature, inhabiting soil, water and plants, and are importantly involved in a wide range of animal and plant parasitic diseases. Nematodes thrive in virtually all environments throughout the world and are one of the largest and most diverse groups of multicellular organisms. Many species are parasites of agronomic crops, but other species are beneficial to agriculture. Nematodes that parasitize plants cause billions of dollars in annual loss to U.S. and international growers. Traditional nematode reduction methods usually rely on a combination of petroleum byproduct soil treatments and crop rotation. Stricter environmental regulations are forecasted to limit the use of petroleum by-products, and threaten to impact agriculture if no safer alternatives are found or invented.

Compositions that act as pesticides are designed primarily to control or knockdown and kill pests by damaging the pest's nervous system. Many pesticidal compositions are toxic to humans and animals and can damage the environment if not used properly. An ideal pesticide has the following characteristics: low toxicity to non-target organisms; low cost; ready availability; a stable shelf life; non-flammability; easy preparation, non-staining; noncorrosive; low odor and rapid breakdown to nontoxic by-products.

The following are ingredients that may be included in any pesticidal composition.

(1) Toxicant or Active Ingredient. This is the basic ingredient that has a toxic action and kills or repels the pest. It's normally shown on a pesticide label as the active ingredient or technical material. Some pesticides, especially those labeled for general use, may contain more than one active ingredient. If so, all active ingredients are listed on the label.

(2) Carrier. The pesticide carrier is mixed with the toxicant to make a finished or semi-finished pesticide product. It normally has no pesticidal action itself and will be listed under inert ingredients on the label. However, there are some carriers, such as most petroleum products, that have some pesticidal action of their own and will be listed under the active ingredients on the label. For liquid pesticides the carrier is normally water or a petroleum-based product, while for most dry pesticides, the carrier is normally talc or diatomaceous earth. Carriers may contain a solvent to dissolve a toxicant that is not readily soluble in a common carrier, thus enabling the toxicant to be added to the carrier and remain in solution. Some pesticides have masking agent added to change or cover the odor of a pesticidal formulation. Carriers may also contain a surfactant to increase the emulsifying, dispersing and/or spreading characteristics of a pesticidal formulation. One of the most common surfactants is called a wetting agent. A wetting agent causes a liquid to cover treated surfaces more thoroughly, and is most commonly used in pesticides applied to vegetation. Emulsifiers are used in liquid pesticides to help suspend one type of liquid (such as an oil-based toxicant) in another (such as water carrier). Essentially, as used herein, “carrier” means an inert or fluid material, which may be inorganic or organic and of synthetic or natural origin, with which the toxicant/active ingredient is mixed or formulated to facilitate its application or storage, transport and/or handling.

(3) Synergist. A synergist is a chemical product added to a pesticide to increase or enhance the effectiveness of a pesticide's active ingredient. Typically, a pesticide product may contain approximately 5-20 times more synergist than active ingredient. A synergist may have active ingredient qualities itself and, if so, will be listed on the label as a secondary active ingredient. When a main active ingredient and synergist are combined, the enhanced effectiveness of the combined product is greater than the accumulative effect that would be achieved if the products were applied separately. Synergists are found in most all household, livestock and pet aerosol pesticides to enhance the action of the fast knockdown pesticides, e.g., pyrethrum, allethrin, and resmethrin, against flying insects. Synergists like piperonyl butoxide (PBO) are required in pesticidal formulations containing pyrethrum, for example, because target insects produce an enzyme (cytochrome P-450) that attacks pyrethrum and breaks it down, thereby making it effective in knocking an insect down, but ineffective for killing in many cases. As such, these synergists act by inhibiting P-450 dependent polysubstrate monooxygenases enzymes (PSMOs) produced by microsomes, which are subcellular units found in the liver of mammals and in some insect tissues that degrade pyrethrum and other pesticidal compounds, such as pyrethrum, allethrin, resmethrin, and the like. These synergists act by inhibiting P-450 enzymes and other like compounds that are part of the gene battery that comprise Phase I and Phase II drug metabolizing enzymes.

However, PBO affects humans by inhibiting important liver enzymes responsible for breakdown of some toxins, including the active ingredients of pesticides. Specifically, it has been shown to inhibit hepatic microsomal oxidase enzymes in laboratory rodents and interfere in humans. Because these enzymes act to detoxify many drugs and other chemicals, a heavy exposure to an insecticidal synergist may make a person temporarily vulnerable to a variety of toxic insults that would normally be easily tolerated. In addition to the symptoms induced by the active ingredients, signs of PBO poisoning include anorexia, vomiting, diarrhea, intestinal inflammation, pulmonary hemorrhage and perhaps mild central nervous system depression. Repeated contact with PBO may also cause slight skin irritation. Chronic toxicity studies have shown increased liver weights, even at the lowest doses, 30 mg/kg/day. Animal studies have shown hepatocellular carcinomas, even treatments as low as 1.2%. The U.S. Environmental Protection Agency considers PBO to be a class C possible human carcinogen. As such, the use of PBO as synergists has become undesirable despite its ability to enhance the efficacy of pyrethrins.

Over the years, pesticidal compositions containing synthetic chemical toxicants have provided an effective means of pest control. For example, one approach teaches the use of complex organic insecticides. Other approaches employ absorbent organic polymers for widespread dehydration of the insects. Use of inorganic salts as components of pesticides has also been tried. However, it has become increasingly apparent that the widespread use of synthetic chemical pesticides has caused detrimental environmental effects that are harmful to humans and other animals. For instance, the public has become concerned about the amount of residual chemicals that persist in food, ground water and the environment, and that are toxic, carcinogenic or otherwise incompatible to humans, domestic animals and/or fish. Moreover, some target pests have even shown an ability to develop resistance to many commonly used synthetic chemical pesticides. In recent times, regulatory guidelines have encouraged a search for potentially less dangerous pesticidal compositions via stringent restrictions on the use of certain synthetic pesticides. As a result, elimination of effective pesticides from the market has limited economical and effective options for controlling pests.

As an alternative, botanical pesticides are of great interest because they are natural pesticides, i.e., toxicants derived from plants that are relatively more safe to humans and the environment. Use of food-grade plant essential oils have been tried. However, these plant essential oils when used alone can be expensive, impractical or ineffective under certain circumstances.

Pyrethrum is a natural pesticide extracted from the flowers of a chrysanthemum grown in Kenya and Ecuador. Pyrethrum acts as an insecticide with phenomenal speed causing immediate paralysis, while at the same time exhibits negligible toxic effects on humans and warm-blooded animals. Use of pyrethrum for industrial or agricultural applications, however, is disadvantageous in that frequent treatments are required because pyrethrum becomes volatile when in contact with water and readily decomposes when exposed to direct sunlight light. Pyrethrum extracts are also undesirably neurotoxic to cold-blooded animals, such as fishes, snakes, etc. Moreover, the supply of pyrethrums is limited and substantial processing is required to bring the natural product to market, and large-scale production of pyrethrum is very expensive and unless pyrethrum is formulated with a synergist, most initially paralyzed insects recover to once again become pests.

Because pyrethrum is limited in availability and is very expensive, the industry has turned to synthetic pyrethroids, which are very photostable in sunlight and are generally effective against most agricultural insect pests. Pyrethroids are not as safe as pyrethrums, however, and disadvantageously persist in the environment for longer periods. Further, many insects disadvantageously develop resistance to pyrethroids.

Many natural products used as insecticides, including plant essential oils, do not provide adequate control of pests in that they either act very slowly or are not very stable and break down quickly, thereby failing to provide quick knockdown of insects or toxic residual properties. Even products such as pyrethrum, although highly toxic to pests on contact when used properly in pesticidal formulations, are not effective pesticides for many applications because they lack residual properties, thereby increasing the frequency and cost of pesticide applications, as well as increased risk and exposure to the environment.

Accordingly, there is a need for novel synergistic and residual pesticidal compositions containing no level or substantially lower levels of pyrethrum, chlorinated hydrocarbons, organo phosphates, carbamates and the like. There is also a need for compounds that act as novel synergists for plant essential oils that are used against invertebrate pests, including insects, arachnids, larvae and eggs thereof. In addition, there is a need for a method of treating a locus to be protected to control (kill and/or repel) invertebrate pests.

There is also acute need for new pesticidal agents and methods to eradicate pest that have developed resistance to pesticides in current use. In general, an insect strain or population is considered “resistant” if it exhibits tolerance to a test insecticide (assessed as the dose required to poison 50% of a treated population or group) that is at least 2 times greater, preferably 4-8 times greater, and most preferably at least 10 times greater than the tolerance of an appropriate reference, or “susceptible” population. The development of resistance to some of the older pesticides, such as pyrethroids, DDT, the carbamates, and the organophosphates, is well known. But resistance has even developed to some of the newer pesticides. Therefore, a need exists for new pesticidal agents and methods and particularly for pesticides that have new modes of action.

### SUMMARY OF THE INVENTION

The exemplary embodiments provide novel pesticidal compositions and methods for use against pests such as invertebrate insects, arachnids, fungi, nematodes, mollusks, worms, slugs, snails, larvae and eggs thereof, etc. In particular, the exemplary embodiments provide novel pesticidal compositions and methods for using same to control pests. The methods of the present invention are suitable for combating pests encountered in and on companion animals, in agriculture, in forestry, in the protection of stored products and of materials, and in the hygiene field. Compounds employed in the methods of the invention have good plant tolerance or favorable safety to warm-blooded animals.

In general, the pesticidal compositions disclosed herein contain a pesticidally-acceptable carrier, a pesticidally-active ingredient comprising, consisting essentially of, or consisting of at least one GABA receptor modulator, e.g., an essential oil compound or monoterpenoid compound; and optionally an additive, such as for example a synergist. Methods for using the pesticidal compositions disclosed herein are pesticidally-effective against a variety of pests by controlling (repelling, knocking down and/or killing) them and/or applying to a locus where control is desired a pesticidally-effective amount of the pesticidal composition.

Without wishing to be bound by any theory of operation, the pesticidally-active compositions are believed to have a neurological effect. Their pesticidal target sites may be defined as the specific biochemical or physiological sites within an target organism that the pesticide compositions interact with to create a toxic effect. The neurological target sites may include acetylcholinesterase enzyme, voltage-gated sodium channels, Glutamate- and GABA-gated chloride channels, nicotinic acetylcholine receptors, octopamine receptors, tyramines receptors, etc. The actions of pesticides at these sites are diverse and range from enzyme inhibition, to receptor agonism (stimulation), receptor antagonism (blockage), ion channel modulation, etc.

Glutamate and GABA (gamma-aminobutyric acid) are inhibitory neurotransmitters that elicit the influx of chloride ions into central neurons through chloride channels. As such, it is to be understood that the pesticidally-active compositions useful according to the present invention do not necessarily possess the ability to modulate one pesticidal target site (e.g., a sole biological receptor site). Spinosad, as an example, is believed to have an effect on both the GABA-gated chloride channel as well as targeting the nicotinic acetylcholine receptor. Thus, in one aspect, the primary requirement for a suitable pesticidally-active composition and method of using same according to the present invention is that it at least modulates GABA receptors, as described herein.

Generally, the pesticidal compositions disclosed herein are particularly active against all or individual stages of development of the pests and against normally sensitive species and resistant species, i.e. species that have developed resistance against the conventionally used pesticides and pesticide application protocols. The compositions may also be useful for controlling pests that have proven to be unaffected by the contemporary pesticides either completely or requiring unacceptable high doses to provide adequate control.

The pesticidal compositions and methods disclosed herein knockdown and kill or otherwise control pests by at least modulating GABA receptors. The exemplary embodiments further provide a method of treating a locus where pest control (i.e., repellency, knockdown and/or kill) is desired using a relatively safe pesticidal composition and method that will not harm mammals or the environment. The pesticidal compositions of the exemplary embodiments can be applied and used as liquid sprays, crystals, gels, and pellets, impregnating material, such as posts, etc.

In addition, methods of using pesticidal compositions disclosed herein may be exempted registration with the U.S. Environmental Protection Agency under applicable sections of the Federal Insecticide, Fungicide and Rodenticide Act and may also be allowable for use in organic farming under the Organic Materials Review Institute and the National Organic Program.

As used herein, a “modulator” that modulates the activity of or interacts with a biological receptor site (e.g., a GABA or nicotinic AChR receptor) and refers to a substance, compound, composition, agent or signal that alters the activity of the biological receptor so that activity of the biological receptor is different in the presence of the compound or signal than in the absence of the compound or signal. In particular, modulators include agonists, antagonists, and partial agonists. The term “agonist” refers to a substance or signal that activates a receptor function, such as excitation or inhibition of action potentials when it binds to a specific receptor; and the term “antagonist” refers to a substance that interferes with receptor function when it binds to a receptor, blocks the receptor and prevents it from responding. Typically, the effect of an “antagonist” is observed as a blocking of activation by an agonist. Antagonists include competitive and non-competitive antagonists. A competitive antagonist (or competitive blocker) interacts with or near the site specific for the agonist (e.g., ligand or neurotransmitter) for the same or closely situated site. A non-competitive antagonist or blocker inactivates the functioning of the receptor by interacting with a site other than the site that interacts with the agonist.

Further, an “agonist” can be a substance that activates its binding partner. Activation can be defined in the context of the particular assay, or may be apparent in the literature from a discussion herein that makes a comparison to a factor or substance that is accepted as an “agonist” or “partial agonist” of the particular binding partner by those of skill in the art. Activation can be defined with respect to an increase in a particular effect or function that is induced by interaction of the agonist or partial agonist with a binding partner and can include allosteric effects.

Moreover, an “antagonist” can be a substance that inhibits its binding partner, typically a receptor. Inhibition is defined in the context of the particular assay, or can be apparent in the literature from a discussion herein that makes a comparison to a factor or substance that is accepted as an “antagonist” of the particular binding partner by those of skill in the art. Inhibition can be defined with respect to a decrease in a particular effect or function that is induced by interaction of the agonist with a binding partner, and can include allosteric effects.

As used herein, the term “pest” refers to invertebrates, organisms and microorganisms, including pathogens, that negatively affect plants or animals by colonizing, attacking or infecting them. This includes organisms that spread disease and/or damage the host and/or compete for host nutrients. In addition, plant pests are organisms known to associate with plants and which, as a result of that association, causes a detrimental effect on the plant's health and vigor. Plant pests include but are not limited to fungi, bacteria, insects, arachnids, nematodes, slugs, snails, etc.

The term “pesticide” as used herein refers to a substance that can be used in the control of agricultural, natural environmental, and domestic/household pests, such as insects, fungi, bacteria, and viruses. The term “pesticide” is understood to encompass naturally occurring or synthetic chemical insecticides (larvicides, and adulticides), insect growth regulators, acaricides (miticides), nematicides, ectoparasiticides, bactericides, fungicides, and herbicides (substance which can be used in agriculture to control or modify plant growth).

The term “plant” as used herein encompasses whole plants and parts of plants such as roots, stems, leaves and seed, as well as cells and tissues within the plants or plant parts. Target crops to be protected within the scope of the exemplary embodiments include, without limitation, the following species of plants: cereals (wheat, barley, rye, oats, rice, sorghum and related crops), beet (sugar beet and fodder beet), forage grasses (orchard grass, fescue, and the like), drupes, pomes and soft fruit (apples, pears, plums, peaches, almonds, cherries, strawberries, raspberries and blackberries), leguminous plants (beans, lentils, peas, soybeans), oil plants (rape, mustard, poppy, olives, sunflowers, coconuts, castor oil plants, cocoa beans, groundnuts), cucumber plants (cucumber, marrows, melons) fiber plants (cotton, flax, hemp, jute), citrus fruit (oranges, lemons, grapefruit, mandarins), vegetables (spinach, lettuce, asparagus, cabbages and other Brassicae, onions, tomatoes, potatoes, paprika), lauraceae (avocados, carrots, cinnamon, camphor), deciduous trees and conifers (e.g., linden-trees, yew-trees, oak-trees, alders, poplars, birch-trees, firs, larches, pines), or plants such as maize, tobacco, nuts, coffee, sugar cane, tea, vines, hops, bananas and natural rubber plants, as well as ornamentals (including composites).

The terms “control” or “controlling” used throughout the specification and claims, are meant to include any pesticidal (killing) or pestistatic (inhibiting, maiming or generally interfering) activities of a pesticidal composition against a given pest. Thus, these terms not only include killing, but also include such activities as those of chemisterilants which produce sterility in insects by preventing the production of ova or sperm, by causing death of sperm or ova, or by producing severe injury to the genetic material of sperm or ova, so that the larvae that are produced do not develop into mature progeny. The terms also include repellant activity that protect animals, plants or products from insect attack by making food or living conditions unattractive or offensive to pests. These repellant activities may be the result of repellents that are poisonous, mildly toxic, or non-poisonous to pests.

As used herein, “inert ingredients” or “inerts” denote chemicals used in pesticide products to make a pesticide, e.g, solvents, surfactants, propellants and carriers, that are pesticidally inactive, i.e., do not possess pesticidal efficacy of their own. Examples of inert ingredients include, but are not limited to, the following types of ingredients (except when they have a pesticidal efficacy of their own): solvents such as alcohols and hydrocarbons; surfactants such as polyoxyethylene polymers and fatty acids; carriers such as clay and diatomaceous earth; thickeners such as carrageenan and modified cellulose; wetting, spreading, and dispersing agents; propellants in aerosol dispensers; microencapsulating agents; emulsifiers; etc.

The exemplary embodiments may be used in the control of agricultural, natural environmental, and domestic/household pests, such as invertebrate insects, arachnids, larvae and eggs thereof, as well as against fungi, bacteria, and viruses.

In one aspect, the exemplary embodiments relate to pesticidal compositions containing at least one plant essential oil compound and methods for using same against household pests (flying and crawling) including but not limited to cockroaches, ants, flies and spiders; plant pests, including but not limited to mites, aphids, thrips, whiteflies, loopers, worms (flat and round), beetles, leafrollers, moths and weevils; and invertebrates such as insects, arachnids, larvae and eggs thereof.

In a further aspect, the exemplary embodiments relate to the pesticidal compositions disclosed herein a repellent against invertebrate pests.

The exemplary embodiments further relate to various optimum ratios between and among the pesticidally active components and the proper delivery system for each blend. The ratio of inert carrier to active ingredient is the ratio wherein a pesticidal effect is achieved and usually, for example, anywhere from approximately: 100:1 to 1:100 parts by weight; 75:1 to 1:75 parts by weight; 65:1 to 1:65 parts by weight; 55:1 to 1:55 parts by weight; 50:1 to 1:50 parts by weight; 40:1 to 1:40 parts by weight; 20:1 to 1:20 parts by weight; 10:1 to 1:10 parts by weight; or 5:1 to 1:5 parts by weight. Optimally, the amount of pesticidally active compound present is approximately 0.0001% to 25% or more of the total pesticidal composition.

GABA Mode Of Action

GABA (γ-Aminobutyric acid) receptors are intrinsic membrane glycoproteins in vertebrate and invertebrate neuronal tissues that are members of the ligand-gated ion channel superfamily of receptors. GABA receptors play a major role in the inhibition of central nervous system (CNS) neuronal activity due to the widespread distribution of GABA-releasing and GABA-receptive neurons.

Vertebrate GABA receptors can be divided into two major classes: the GABA_{A} and GABA_{C} subtypes, and GABA_{B} receptor subtype, which are distinguished by differences in their effector mechanisms and pharmacology. GABA_{A} and GABA_{C} receptors are believed to be transmitter-operated chloride channels that are activated by GABA to open their chloride channel while GABA_{B} receptors are thought to mediate changes in cyclic AMP levels through the activation of phospholipase activity. The GABA_{A} receptor and its associated chloride ion channel make up the so-called GABA_{A} receptor-channel complex.

GABA is the endogenous ligand for the GABA_{A} receptor of the GABA_{A}-complex, and is the major inhibitory neurotransmitter in the vertebrate brain, in the insect CNS and at insect neuromuscular junctions. GABA binding to its receptor stimulates chloride ion conductance through the associated chloride ion channel to inhibit synaptic transmission. When two molecules of GABA bind at sites on the receptor, the chloride channel undergoes a conformational change and opens, allowing chloride ions to flow passively down the electrochemical gradient into the neuron. An influx of chloride into the cell causes a change in the membrane potential, usually a hyperpolarization, which results in an inhibition of the nerve impulse. Blockage of the GABA-gated chloride channel reduces neuronal inhibition, which leads to hyper-excitation of the CNS, resulting in convulsions and death. In contrast, irreversible hyperactivation of the channel suppresses neuronal activity, resulting in ataxia, paralysis, coma and death.

GABA_{A} receptors belong to the class 1 family of neurotransmitter/hormone receptors. Other class 1 members include the glycine receptor, the serotonin type-3 receptor, the nicotinic acetylcholine receptors (muscle and neuronal types) and several excitatory amino acid receptors of vertebrates. Class 1 receptors employ no second messengers and are found where a fast conductance is required. In contrast to class 1 receptors, class 2 receptors (e.g., muscarinic, adrenergic, and others) are coupled to a second messenger and/or a G protein for their transduction, with the channel involved being separate (and usually distant) from the receptor, which is both an agonist-binding and G protein-binding molecule.

GABA_{A} receptors are pentameric oligomers, of about 250 kilodaltons (kDa), composed of six different types of subunits, α, β, γ, δ, ε and ρ, each of approximately 50 kDa. Each subunit comprises a large extracellular N-terminal domain that putatively includes the ligand-binding site, four hydrophobic presumed membrane-spanning domains, one or more of which contribute to the wall of the ion channel, and a small extracellular C-terminus. Heterologous expression in vitro of different combinations of GABA receptor subunit types (α, β, γ, δ, etc.) and subunit isoforms (α1, α2, etc. except δ) results in heteromultimeric receptors with differing structure and pharmacology.

GABA receptors also believed to play an important role in the chemical control of pests, particularly insects, such as fleas, ticks, house flies, fruit flies, plant bugs, boll weevils, grasshoppers, cockroaches, mosquitoes, beetles, locust, moths, nematodes, snails, slugs, etc. To date, all insect GABA receptors studied gate a fast acting chloride ion conductance. Although they appear to share many of the properties of GABA_{A}-type receptors in the vertebrate CNS, the majority of receptors in the insect nervous system appear to be bicuculline-, pitrazepin- and RU5135-insensitive. These findings indicate that insect GABA receptors contain several drug binding sites with structural and target site specificities that are different from vertebrate receptor-binding sites. Selective insecticides, e.g., insecticides with favorable selective toxicity for insects relative to vertebrates, are based in part on this target-site specificity between the GABA receptors of insects and the GABA_{A} receptors of vertebrates.

Radiolabeled ligand binding studies have considerably expanded the knowledge of insect GABA receptor pharmacology. Within the insect GABA receptor three distinct binding sites have been identified: the GABA receptor agonist binding site, a benzodiazepine binding site and a convulsant binding site. The convulsant binding site of GABA receptors in pests is the major target site for many of the drugs and pesticides currently on the market.

Convulsant drugs and pesticides act at the GABA receptor in pest brain, ganglia and muscle as noncompetitive blockers. Inhibition of GABA receptors in pests produces neurotoxicity (e.g., convulsions, paralysis, coma and death). In the early 1980s, the pesticides lindane and cyclodienes (e.g., dieldrin) were shown to antagonize the action of GABA in stimulating chloride uptake by various pest nerve and muscle preparations. GABA receptors in pests are also blocked by picrotoxin, phenylpyrazole pesticides (e.g., Fipronil®, vaniliprole, pyrafluprole, pyriprole, ethiprol, etc.), bicyclophosphorous esters (e.g., t-butylbicyclophosphoronthionate), and bicycloorthobenzoates (4-n-propyl-4′-ethynylbicycloorthobenzoate). Other examples of compounds that exhibit GABA antagonist activity include acetoprole, endosulfan, imidacloprid, acetamiprid, nitenpyram, thiamethoxamethiprole, etc. These pesticides block transmission of signals by GABA, and are very effective on a wide range of economically important pests.

Unfortunately, many potent pesticides and their derivatives also act at the GABA_{A} receptors of animals. For example, fipronil sulfone and desulfinyl fipronil, a metabolite and photoproduct of fipronil, respectively, are not only toxic to pests, but also to upland game birds, freshwater fish and invertebrates, and waterfowl. In addition, fipronil itself is a toxicant for mammals even without oxidation to the sulfone.

Glutamate- or GABA-gated chloride channel agonist pesticide compounds are a well known and versatile group of compounds that are used as agrochemicals. The compounds are known to have both insecticidal, acaricidal and anthelminthic (nematicidal) effect even when applied at very low rates compared to other agrochemicals. They are equally suitable for controlling both plant pests and ecto- and endo-parasites. Their mode of action is based on the interference with the passage of chloride ions through the Glutamate or GABA regulated chloride ion channels, which results in uncontrolled physiological activity and subsequent death of the pest. One effect is inhibitory, i.e., the compound interferes agonistically with the function of the Glutamate- or GABA-gated chloride channels and elicits increased chloride current into cells. The increased chloride current results in intracellular hyperpolarization and (neuro) inhibition via the cancellation of positively charged excitatory impulses carried by sodium currents, and eventually leads to the death of the pest.

Pesticides that effectively kill pests but that have little toxicity for animals and humans remain the aim of current research efforts. The present invention addresses the need for the development and use of new and more efficacious pesticides that are highly toxic to pests but not to animals susceptible to pest infestation. In a further aspect, the exemplary embodiments relate to a method for controlling (e.g., knocking down or killing) invertebrates such as insects, arachnids, larvae and eggs thereof, including but not limited to cockroaches, ants, flies, spiders, mites, aphids, thrips, whiteflies, loopers, worms, beetles, leafrollers, moths and weevils, by the application of pesticidally effective amounts of the pesticidal compositions disclosed herein to a location where invertebrate pest control is desired.

As such, one exemplary embodiment is a method for inhibiting a pest GABA receptor, comprising contacting one or more pest GABA receptors with a monoterpenoid compound-containing pesticidal composition.

Another exemplary embodiment is a method for controlling pests, comprising contacting an animal, plant or object with a pesticidal composition comprising: (a) a pesticidally effective amount of a monoterpenoid compound and (b) one or more pesticidally-acceptable excipients or carriers.

### BRIEF DESCRIPTION OF THE DRAWINGS

The accompanying drawings, which are incorporated in and constitute a part of the specification and written description, illustrate the exemplified embodiments and, together with the description, serve to exemplify the principles of the claims.

FIG. 1 shows results of inhibition of [3H]-TBOB Binding by Dieldrin to Mouse GABAa receptor and House Fly GABA receptor. Points are means±S.D. (n=3). IC⁵⁰ of Dieldrin in mouse=3.78±0.45 μM, IC⁵⁰ of Dieldrin in House Fly=12.71±4.43 nM. (Means±S.D., n=3).

FIG. 2 shows results of inhibition of [3H]-TBOB Binding by Lindane to Mouse GABAa receptor and House Fly GABA receptor. Points are means±S.D. (n=3). IC⁵⁰ in mouse=75.86±11.33 nM μM, IC⁵⁰ in House Fly=14.24±2.19 nM. (Means±S.D., n=3).

FIG. 3 shows results of modulation of [3H]-TBOB Binding by Pulegone to Mouse GABAa receptor and House Fly GABA receptor. Points are means±S.D. (n=3). IC⁵⁰ in Mouse=15.52±3.37 mM. (Means±S.D., n=3).

FIG. 4 shows results of modulation of [3H]-TBOB Binding by Thymol to Mouse GABAa receptor and House Fly GABA receptor. Points are means±S.D. (n=3).

FIG. 5 shows results of modulation of [3H]-TBOB Binding by Linalool to Mouse GABAa receptor and House Fly GABA receptor. Points are means±S.D. (n=3).

FIG. 6 shows results of modulation of [3H]-TBOB Binding by alpha-terpineol to Mouse GABAa receptor and House Fly GABA receptor. Points are means±S.D. (n=3).

FIG. 7 shows results of modulation of [3H]-TBOB Binding by carvacrol to Mouse GABAa receptor and House Fly GABA receptor. Points are means±S. D. (n=3).

FIG. 8 shows results of GABA Activated ³⁶Cl— Uptake Assay completed using membrane microsacs prepared from American cockroach, Periplaneta americana. Positive control-antagonists. [Antagonists]=10 μM, p<0.01.

FIG. 9 shows results of GABA Activated ³⁶Cl— Uptake Assay completed using membrane microsacs prepared from American cockroach, Periplaneta americana. Positive control-agonists. [Muscimol]=100 μM, p<0.01.

FIG. 10 shows results of GABA Activated ³⁶Cl— Uptake Assay completed using membrane microsacs prepared from American cockroach, Periplaneta americana for Monoterpenoids carvacrol, thymol, and pulegone.

FIG. 11 shows results of GABA Activated ³⁶Cl— Uptake Assay completed using membrane microsacs prepared from American cockroach, Periplaneta Americana for Thymol.

FIG. 12 shows results of GABA Activated ³⁶Cl— Uptake Assay completed using membrane microsacs prepared from American cockroach, Periplaneta americana for Carvacrol.

FIG. 13 shows results of GABA Activated ³⁶Cl— Uptake Assay completed using membrane microsacs prepared from American cockroach, Periplaneta americana for Pulegone.

FIG. 14 shows results of GABA Activated ³⁶Cl— Uptake Assay completed using membrane microsacs prepared from American cockroach, Periplaneta americana for Alpha-terpineol.

FIG. 15 shows a schematic interpretation of results from the GABA-activated ³⁶Cl— Uptake Assay A) Chloride uptake through membrane microsacs, B) Antagonist and Agonist uptake, C) Allosteric Modulator uptake.

### DETAILED DESCRIPTION OF PREFERRED EMBODIMENTS

All patents, patent applications and literatures cited in this description are incorporated herein by reference in their entirety.

As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but may include other elements not expressly listed or inherent to such composition, mixture, process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the invention are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

It has been surprisingly found that GABA receptor modulator-containing pesticidal compositions have a broad spectrum of activity and are particularly effective against, but not limited to, insects having a cuticle or proteinaceous exoskeleton or the like. Furthermore, such compositions comprise additional natural or essential oils as additional components and is therefore particularly advantageous in terms of its relative non-toxicity. Generally, the pesticidal compositions are generally active against all or individual stages of development of the pests and against normally sensitive species and resistant species, i.e. species that have developed resistance against the other pesticides. The pesticidal compositions disclosed herein may also be useful for controlling pests that have proven to be unaffected by the other pesticides either completely or requiring unacceptable high doses to provide adequate control.

Generally, monoterpenes (monoterpenoids) are plant secondary metabolites that are found in higher order plants. These compounds' biosynthesis utilizes two isoprene units, to produce a 10-carbon molecule. Biosyntheses of monoterpenoids are accomplished primarily via the mevalonic acid pathway, although some of the aromatic species are synthesized from aromatic amino acid precursors. Monoterpenoids are further processed by the plant through various oxidation steps to produce alcohols, aldehydes, carboxylic acids, ethers, and epoxides. Cyclization reactions also contribute to generation of a wide diversity of molecules. Derivatization of alcohols, e.g., acetylation or methylation, can also yield additional variety in the basic monoterpene group. These compounds seem to play no major role in the metabolic functions of the plant, and one reproductive function is to aid in pollination of the plant by attracting certain insects or other pollinators to the plant. Another function of monoterpenoids is thought to be defense against plant pathogens, herbivores, or competing plant species.

It is believed that certain monoterpenes and other essential oil compounds have heretofore not been known to be effective GABA receptor modulators that exhibit pesticidal effects by modulating GABA receptor sites. This class of novel natural pesticidal compounds can be characterized as having at least one of the following features:

a cyclohexane ring

a cyclohexene ring

a cyclohexadiene ring

an aromatic ring

no ring (i.e., they are acyclic).

In one aspect, an exemplary embodiment of the invention is directed to a method for interacting with the neurotransmitters of GABA receptor sites in a pest to thereby kill and/or affect the feeding habits and/or growth of the pest without similarly affecting mammals, fish or fowl, the method comprising:
selecting at least one affector agent based on the ability of the affector agent to interact or modulate the GABA receptor sites in the pest, the affector agent comprising at least one member selected from the group consisting of the GABA receptor modulators listed hereinbelow;
applying to the pest or their habitat, a pesticidal composition comprising a pesticidally-acceptable carrier and said at least one affector agent,
wherein the affector agent is present in the pesticidal composition in a pesticidally-effective amount to modulate the GABA receptor sites to kill or affect the feeding and/or growth of the pest without being harmful to mammals, fish or fowl.

In a further aspect, another exemplary embodiment of the invention is directed to a method for inhibiting a pest GABA receptor, comprising contacting one or more pest GABA receptors with a pesticidal composition comprising a pesticidally-acceptable carrier and at least one member selected from the group consisting of the GABA receptor modulators listed hereinbelow.

In a still further aspect of the invention, another exemplary embodiment is directed to a method for controlling pests, comprising contacting a pest, animal, plant or inanimate object with a pesticidally-effective amount of a pesticidal composition comprising a pesticidally-acceptable carrier and at least one member selected from the group consisting of the GABA receptor modulators listed hereinbelow.

Suitable affector agents or GABA receptor modulators that may be combined or mixed with a pesticidally-acceptable carrier to provide a pesticidally-effective composition or pesticide, include, without limitation: thymol, eugenol, carvacrol, alpha-terpineol, 2-phenethyl propionate, pulegone and the like, including racemic mixtures, enantiomers, diastereomers, hydrates, salts, solvates and metabolites, thereof, etc. Additional suitable examples of affector agents or GABA receptor modulators include, without limitation, those monoterpenoid compounds selected from the group consisting of:

α-pinene or β-pinene; α-campholenic aldehyde; α-citronellol; α-iso-amyl-cinnamic (e.g., amyl cinnamic aldehyde); α-pinene oxide; α-cinnamic terpinene; α-terpineol (e.g., 1-methyl-4-isopropyl-1-cyclohexen-8-ol); λ-terpinene; achillea; aldehyde C16 (pure); alpha-phellandrene; amyl cinnamic aldehyde; amyl salicylate; anethole; anise; aniseed; anisic aldehyde; basil; bay; benzyl acetate; benzyl alcohol; bergamot (e.g., Monardia fistulosa, Monarda didyma, Citrus bergamia, Monarda punctata); bitter orange peel; black pepper; white pepper; borneol; calamus; camphor; cananga oil (e.g., java); cardamom; carnation (e.g., dianthus caryophyllus); carvacrol; carveol; cassia; castor; cedar (e.g., hinoki); cedarwood; chamomile; cineole; cinnamaldehyde; cinnamic alcohol; cinnamon; cis-pinane; citral (e.g., 3,7-dimethyl-2,6-octadienal); citronella; citronellal; citronellol dextro (e.g., 3,7-dimethyl-6-octen-1-ol); citronellol; citronellyl acetate; citronellyl nitrile; citrus unshiu; clary sage; clove (e.g., eugenia caryophyllus); clove bud; coriander; corn; cotton seed; 6-tert-butyl-m-cresol; d-dihydrocarvone; decyl aldehyde; diethyl phthalate; dihydroanethole; dihydrocarveol; dihydrocarvacrol; dihydrolinalool; dihydromyrcene; dihydromyrcenol; dihydromyrcenyl acetate; dihydroterpineol; dimethyl salicylate; dimethyloctanal; dimethyloctanol; dimethyloctanyl acetate; diphenyl oxide; dipropylene glycol; d-limonene; d-pulegone; estragole; ethyl vanillin (e.g., 3-ethoxy-4-hydrobenzaldehyde); eucalyptol (e.g., cineole); eucalyptus citriodora; eucalyptus globulus; eucalyptus; eugenol (e.g., 2-methoxy-4-allyl phenol); evening primrose; fenchol; fennel; Feniol™ (phenethyl alcohol and caprylyl glycol); fish oil; florazon (e.g., 4-ethyl-α,α-dimethyl-benzenepropanal); galaxolide; geraniol (e.g., 2-trans-3,7-dimethyl-2,6-octadien-8-ol); geraniol; geranium; geranyl acetate; geranyl nitrile; ginger; grapefruit; guaiacol; guaiacwood; gurjun balsam; heliotropin; herbanate (e.g., 3-(1-methyl-ethyl)bicyclo(2,2,1) hept-5-ene-2-carboxylic acid ethyl ester); hiba; hydroxycitronellal; i-carvone; i-methyl acetate; ionone; isobutyl quinoleine (e.g., 6-secondary butyl quinoline); isobornyl acetate; isobornyl methylether; isoeugenol; isolongifolene; jasmine; jojoba; juniper berry; lavender; lavandin; lemon grass; lemon; lime; limonene; linallol oxide; linallol; linalool; linalyl acetate; linseed; litsea cubeba; l-methyl acetate; longifolene; mandarin; mentha; menthane hydroperoxide; menthol crystals; menthol laevo (e.g., 5-methyl-2-isopropyl cyclohexanol); menthol; menthone laevo (e.g., 4-isopropyl-l-methyl cyclohexan-3-one); methyl anthranilate; methyl cedryl ketone; methyl chavicol; methyl hexyl ether; methyl ionone; mineral; mint; musk ambrette; musk ketone; musk xylol; mustard (also known as allylisothio-cyanate); myrcene; nerol; neryl acetate; nonyl aldehyde; nutmeg (e.g., myristica fragrans); orange (e.g., citrus aurantium dulcis); orris (e.g., iris florentina) root; para-cymene; para-hydroxy phenyl butanone crystals (e.g., 4-(4-hydroxyphenyl)-2-butanone); passion palmarosa oil (e.g., cymbopogon martini); patchouli (e.g., pogostemon cablin); p-cymene; pennyroyal oil; pepper; peppermint (e.g., mentha piperita); perillaldehyde; petitgrain (e.g., citrus aurantium amara); phenyl ethyl alcohol; phenyl ethyl propionate; phenyl ethyl-2-methylbutyrate; pimento berry; pimento leaf; pinane hydroperoxide; pinanol; pine ester; pine needle; pine; pinene; piperonyl; piperonyl acetate; piperonyl alcohol; plinol; plinyl acetate; pseudo ionone; rhodinol; rhodinyl acetate; rosalin; rose; rosemary (e.g., rosmarinus officinalis); ryu; sage; sandalwood (e.g., santalum album); sandenol; sassafras; sesame; soybean; spearmint; spice; spike lavender; spirantol; starflower; tangerine; tea seed; tea tree; terpenoid; terpineol; terpinolene; terpinyl acetate; tert-butylcyclohexyl acetate; tetrahydrolinalool; tetrahydrolinalyl acetate; tetrahydromyrcenol; thulasi; thyme; thymol; tomato; trans-2-hexenol; trans-anethole and metabolites thereof; turmeric; turpentine; vanillin (e.g., 4-hydroxy-3-methoxy benzaldehyde); vetiver; vitalizair; white cedar; white grapefruit; wintergreen (e.g., methyl salicylate) and the like.

In another aspect, the pesticidal composition may further comprise at least one additional substance selected from a synergist, stabilizing substance, insecticide, pesticide, acaricide, plant nematicide, anthelmintic, anticoccidial, fungicide, bactericide, antiviral, arthropod attractant, arthropod repellent, arthropod pheromone, vertebrate attractant, vertebrate repellent, vertebrate pheromone, deodorant, flavoring agent, dye, trace element, and vitamin.

In further aspect, the at least one additional substance (e.g., insecticides, acaricides, fungicides, nematicides, etc.) may be added to the pesticidal composition disclosed herein to enhance the pesticidal activity, broaden the spectrum of control or preventing the build-up of resistance, if desired. Suitable examples of such additional active agents include, without limitation, acephate, acetamiprid, acrinathrin, alanycarb, albendazole, aldicarb, alphamethrin, amitraz, avermectins, azadirachtin, azinphos, azocyclotin, Bacillus thuringiensis, bendiocarb, benfuracarb, bensultap, benzoximate, bephenium, betacyfluthrin, bifenazate, bifenthrin, bistrifluoron, BPMC (2-sec-Butylphenyl Methylcarbamate), brofenprox, bromophos, brotianide, bufencarb, buprofezin, butamisole, butocarboxin, butylpyridaben, cadusafos, cambendazole, carbaryl, carbofuran, carbophenothion, carbosulfan, cartap, chloethocarb, chlorfenapyr, chloroethoxyfos, chlorofenvinphos, chlorofluazuron, chloromephos, chlorpyrifos, chromafenozide, cis-resmethrin, clocythrin, clofentezine, clorsulon, closantel, clothianidin, cyanophos, cycloprothrin, cyfluthrin, cyhalothrin, cyhexatin, cypermethrin, cyromazine, deltamethrin, demeton, demeton-S-methyl, diamphenethide, diaveridine, diazinon, dibromosalan, dichlofenthion, dichlorophen, dichlorvos, dicliphos, dicofol, dicrotophos, diethion, diethylcarbamazine, difenthiuron, diflubenzuron, dimethoate, dimethylvinphos, dimetridazole dinotefuran, dioxathion, disulfoton, edifenphos, endosulfan, epsiprantel, esfenvalerate, ethiofencarb, ethion, ethiprole, ethofenprox, ethoprofos, etoxazole, etrimphos, febantel, fenamiphos, fenbendazole, fenbutatin oxide, fenitrothion, fenobucarb, fenothiocarb, fenoxycarb, fenpropathrin, fenpropathrin, fenpyrad, fenpyroximate, fenthion, fenvalerate, fenzaquin, fipronil, flonicamid, fluazinam, fluazuron, flubendazole, flucycloxuron, flucythrinate, flufenoxuron, flufenprox, fluvalinate, fonophos, formothion, fosthiazate, fubfenprox, furathiocarb, gamma-cyhalothrin, haloxon, heptenophos, hexachlorophene, hexaflumuron, hexythiazox, imidacloprid, indoxacarb, iprobenfos, isazophos, isofenphos, isoprocarb, isoxathion, ivermectin, lambda-cyhalothrin, levamisole, lindane, lufenuron, malathion, mebendazole, mecarbam, mesulfenphos, metaldehyde, methacrifos, methamidophos, methidathion, methiocarb, methomyl, methoxyfenozide, methyridine, metolcarb, mevinphos, milbemectin, milbemycins, monocrotophos, morantel, naled, netobimin, niclopholan, niclosamide, nitenpyram, nitroxynil, omethoate, oxamyl, oxfendazole, oxibendazole, oxyclozanide, oxydemethon M, oxydeprofos, parathion A, parathion M, parathion, parbendazol, permethrin, phenothiazine, phenthoate, phorate, phosalone, phosmet, phosphamidon, phoxim, pirimicarb, pirimiphos, praziquantel, profenofos, promecarb, propaphos, propoxur, prothiofos, prothoate, pymetrozin, pyrachlophos, pyrantel, pyresmethrin, pyrethrum, pyridaben, pyridaphenthion, pyrimidifen, pyriproxifen, quinalphos, rafoxanide, rynaxypyr, salithion, sebufos, silafluofen, spirodiclofen, spirotetratmat, sulfotep, sulprofos, tebufenozid, tebufenpyrad, tebupirimiphos, teflubenzuron, tefluthrin, temephos, terbam, terbufos, tetrachlorvinphos, tetramisole, thenium, thiabendazole, thiacloprid, thiafenox, thiamethoxam thiodicarb, thiofanox, thiomethon, thionazin, thiophanate, thuringiensin, tralomethrin, triarathen, triazophos, triazuron, trichlorfon, trichlorfon, triclabendazole, triflumuron, trimethacarb, vamidothion, XMC, xylylcarb, zetamethrin, etc.

Suitable examples of Glutamate- or GABA-gated chloride channel agonist pesticides that also may be added to the pesticidal compositions used according to the invention include, without limitation, avermectins (e.g., Abamectin, Aversectin C, Doramectin, Emamectin, Eprinomectin, Ivermectin, Selamectin and salts thereof), milbemycines (e.g., Milbemectin, Milbemycin oxime, Moxidectin, Lepimectin, Nemadectin and salts thereof) and spinosyns (e.g., Spinosad and Spinetoram).

In a further aspect, suitable examples of additional compounds that may be added to the pesticidal compositions described above in accordance with the present invention include at least one invertebrate pest control agent selected from the group consisting of neonicotinoids; cholineseterase inhibitors; sodium channel modulators; chitin synthesis inhibitors; ecdysone agonists and antagonists; lipid biosynthesis inhibitors; macrocyclic lactones; juvenile hormone mimics; ryanodine receptor ligands; octopamine receptor ligands; mitochondrial electron transport inhibitors; nereistoxin analogs; biological agents; and pesticidally acceptable salts thereof.

The exemplary embodiments provide very efficacious pesticides that, in a preferred aspect, may be designated as biopesticides in that they comprise a chemical substance of natural origin that can be synthesized. Preferred embodiments have a lethal effect on pest targets. Unlike the bulk of currently available pesticides on the market, the preferred pesticidal compositions have active ingredients that have been proven to be substantially non-toxic to man and domestic animals and which have minimal adverse effects on wildlife and the environment.

The exemplary embodiments are advantageous in that they can typically control pests at average or lower than average dosage rates. Such pesticidal compositions are also advantageous in that they can provide extended protection to a locus. Further, such pesticidal compositions are also advantageous in that said pesticidal compositions control pests without introducing a notable amount of harm to the surrounding environment of which the provided pesticidal composition is being utilized.

The pesticidal compositions have pesticidal activity against one or more pests. However, it is understood that certain pesticidal compositions may be more effective on some pests than others, and may even be ineffective against some pests. However, that does not in any way detract from their value as pesticides since the exemplary embodiments contemplate use as broad, general acting pesticides, while others have utility as specific or selective pesticides. The non-limiting Examples set forth below illustrate methods by which the broad-acting or selectivity of pesticidal activity may be readily ascertained by routine experimentation.

The pesticidal compositions of the exemplary embodiments offer several advantages over currently used pesticides. First, the preferred essential oils used in the composition are typically naturally occurring compounds, and as such are relatively nontoxic to humans, domestic animals and wildlife. Consequently, when used for treating plant pests, food crops can be treated using the composition up to and immediately before the harvesting period, a practice that generally is avoided when using conventional methods of pest control. The composition also can be used to control the growth of pest organisms on harvested crops. The harvested food can be used directly as food for animals or humans with little fear of (residual toxicity) or phytotoxicity. By using the subject compositions, the environmental and health hazards involved in pest control are minimized. Because of the versatility and broad spectrum of the present composition, when necessary, the composition can be used as a preventative on a repeated basis and, thus, can be integrated into integrated pest management (IPM) programs. The composition can be applied to skin or to objects such as clothing, fur, feathers, or hair that come into contact with skin when used to treat pests that infest animals. The essential oils, i.e., the active ingredients, of the pesticidal compositions of the exemplary embodiments are believed to be biorational chemicals that may qualify for the U.S. EPA Biopesticide Program.

Another advantage of the pesticidal compositions of the exemplary embodiments is that they have not previously been used against microorganisms, and therefore, fungal and bacterial pathogens and other pest organisms have not acquired resistance to them. Disease resistance to chemicals other than the heavy metals occurs commonly in pests such as fungi and on rare occasions in bacterial plant disease pests. A new pesticide often becomes noticeably less effective against a particular disease after several growing seasons. As pesticides become more specific for diseases, the pests become resistant. This can be attributed to the singular mode of action of a particular pesticide, which disrupts only one genetically controlled process in the metabolism of the pest organism. The result is that resistant populations appear suddenly, either by selection of resistant individuals in a population or by a single gene mutation. Generally, the more specific the site and mode of a pesticidal action, the greater the likelihood for a pest organism to develop a tolerance to that chemical. A new composition will solve the disease resistance problem. To avoid developing future disease resistance in pests, different chemicals should be alternated for treatment with the exemplary methods.

Methods of using the pesticidal compositions of the exemplary embodiments offer several advantages over existing methods of pest control. The formulations provide for effective control of (microorganisms) insects, mites, fungi and microorganisms. In particular situations, such as where an insect damages a plant part or tissue and a secondary fungal disease develops, this aspect may be particularly advantageous. The pesticidal compositions have very good fungicidal properties and can be employed for controlling phytopathogenic fungi, such as, without limitation, plasmodiophoromycetes, oomycetes, chytridiomycetes, zygomycetes, ascomycetes, basidiomycetes, deuteromycetes, etc. Fungal phytopathogens particularly associated with crop plants and included within the scope of the exemplary embodiments include, without limitation, the following: Miscellaneous Fungal Diseases (e.g., Septoria tritici, Septoria nodorum); Gibberella ear mold (e.g., e.g., Gibberella zeae, G. saubinetti); Aspergillus ear rot (e.g., Aspergillus flavus, A. parasiticus); Diplodia ear rot (e.g., Diplodia maydis, D. macrospora); Fusarium ear rot (e.g., Fusarium moniliforme, F. monilif. var. subglutinans); Pythium stalk rot (e.g., Pythium aphanidermata); Anthracnose stalk rot (e.g., Colletotrichum graminicola, C. tucumanensis, Glomerella graminicola); Diplodia stalk rot (e.g., Diplodia maydis, D. zeae-maydis, Stenocarpella maydis, Macrodiplodia zeae, Sphaeria maydis, S. zeae, D. macrospora); Fusarium stalk rot (e.g., Fusarium moniliforme); Gibberella stalk rot (e.g., G. zeae, G. saubinetti); Stewart's wilt & leaf blight (e.g., Erwinia stewartii); Northern corn leaf blight (e.g., Exserohilum turcicum); Southern corn leaf blight (e.g., Bipolaris maydis); Gray leaf spot (e.g., Cercospora zeae-maydis, C. sorghi var. maydis); Anthracnose leaf blight (e.g., Colletotrichum graminicola); Common rust (e.g., Puccinia sorghi, P. maydis); Southern rust (e.g., Puccinia polysora, Dicaeoma polysorum); Head smut (e.g., Sphacelotheca reiliana); Common smut (e.g., Ustilago maydis); Carbonum leaf spot (e.g., Helminthosporium carbonum); Eye spot (e.g., Kabatiella zeae); Sorghum downy mildew (e.g., Peronosclerospora sorghi); Brown stripe downy mildew (e.g., Sclerophthora rayssiae); Sugarcane downy mildew (e.g., Peronosclerospora sacchari); Phillipine downy mildew (e.g., Peronoscler. Philippinensis); Java downy mildew (e.g., Peronosclerospora maydis); Spontaneum downy mildew (e.g., Peronosclerospora spantanea); Rajasthan downy mildew (e.g., Peronosclerospora heteropogoni); Graminicola downy mildew (e.g., Sclerospora graminicola); Rusts (e.g., Puccinia graminis f.sp. tritici, Puccinia recondita f.sp. tritici, Puccinia striiformis); Smuts (e.g., Tilletia tritici, Tilletia controversa, Tilletia indica, Ustilago tritici, Urocystis tritici); Root rots, Foot rots and Blights (e.g., Gaeumannomyces graminis, Pythium spp., Fusarium culmorum, Fusarium graminaerum, Fusarium avenaceum, Drechslere tritici-repentis, Rhizoctonia spp., Colletotrichum graminicola, Helminthosporium spp., Microdochium nivale, Pseudocercosporella herpotrichoides); Mildews (e.g., Erysiphe graminis f.sp. tritici, Sclerophthora macrospora), and the like.

The long term control of pests results in plants with an improved quality and yields of produce by host plants as compared with untreated plants. The low concentration and single dose of anti-pest agents decreases the likelihood of damage to the plant and/or its crop, and decreases the likelihood of adverse side effects to workers applying the pesticide, or to animals, fish or fowl which ingest the tissues or parts of treated plants. The methods of use of the pesticidal compositions will depend at least in part upon the pest to be treated and its feeding habits, as well as breeding and nesting habits. While very minor dosage rates of the novel compositions will have an adverse effect on pests, adequate control usually involves the application of a sufficient amount to either eliminate pests entirely or significantly deter their growth and/or rate of proliferation. Dosage rates required to accomplish these effects, of course, vary depending on the target pest, size, and maturity, i.e., stage of growth. More mature pests may be more resistant to pesticides and require higher dosage rates for a comparable level of control. Dose response experiments using different dilutions (for example, about 1:1000, 1:100, 1:10 and 1:3) of the exemplary embodiments on target organisms and on plants are performed to determine the optimal concentration of the active essential oil compound(s) that show(s) pesticidal activity without phytotoxicity or dermal sensitivity. For instance, when the pesticidal composition of the exemplary embodiments is utilized for agricultural purposes, an amount from about 0.1 to 2,000 g/ha of the active ingredients is employed onto the soil, plants, or directly onto the harmful pests, preferably as an emulsifiable concentrate or emulsion usually at a rate from 1 to 2000 ppm.

In preferred embodiment, the exemplary embodiments are useful for treating (e.g., preventing, controlling, impeding, killing and the like) infectious or pathogenic bacterial, viral, microbial, and other diseases causing pests is provided which includes applying an effective amount of the pesticidal composition to a locus in need thereof for controlling, treating, managing, preventing, or the like, the spread of diseases caused by germs, bacteria, or viruses such as Escherichia coli, salmonella, staphylococci, streptococci, influenza, pneumonia, various blood and urine bacterial pathogens, and the like. The invention further encompasses treatment of the following: gram-positive cocci that cause staphylococcal infections such as pneumonia, bacteremia, osteomyelitis, enterocolitis, and the like; streptococci that cause infections such as hemolytic, viridans, enterococci, lactic, and the like; pneumococci that cause infections such as pneumonia, sinusitis, otitis, Meningitis, and the like; gram-negative cocci such as meningococcus, gonococcus, and the like; gram-positive bacilli that cause infections such as erysipelothricosis, listeriosis, anthrax, nocardiosis, and the like; gram-negative bacilli that cause infections such as enterobacteriaceac salmonella, shigellosis, hemophilus, tularemia, plaque, melioidosis, bartonellosis, campylobacter, and noncholera vibrio, and the like; anaerobic bacilli that cause infections such as clostridium botulinum, clostridium tetany, clostridia of gas gangrene bacteroides, mixed anaerobic, actinomycosis, and the like; mycobacteria that cause infections such as tuberculosis and leprosy, and the like; and spirochetes that cause diseases such as leptospirosis, lyme disease, and endemic treponematoses. Further, the invention, the pesticidal compositions may be useful for treating surfaces containing infectious human immunodeficiency virus (HIV), influenza, A, B, and C, parainfluenza viruses 1-4, rhonoviruses (common cold), mumps virus, adenoviruses, reoviruses, and epstein-Barr virus, infants and adult syncytial virus, primary atypical pneumonia, polioviruses, coxsackieviruses, echoviruses and high numbered viruses, epidemic gastroenteritis viruses, rubeola virus, rubella virus, varicella-zoster virus, herpes simplex, human herpes virus type 6, human parvovirus B19, cytomegalovirus, hepatitis viruses types A, B, C, D, human Papillomavirus, molluscum contagiosum virus, arboviruses, togaviruses, alphaviruses, flaviviruses, bunyaviruses, orbivirus, rabies virus, herpesvirus simiae, arenaviruses, filoviruses, and the like.

In another embodiment, the exemplary embodiments can be formulated with any suitable carrier and optionally with a suitable surface active agent, with and without one or more additional essential oil compounds and derivatives thereof, natural or synthetic, including racemic mixtures, enantiomers, diastereomers, esters, hydrates, salts, solvates and metabolites, etc.

As the above ingredients are known and used for other uses, they may be prepared by a skilled artisan by employing known methods or purchased from numerous sources.

It will be appreciated by the skilled artisan that the pesticidal compositions of the present invention unexpectedly exhibit excellent pesticidal efficacy in lieu of conventional pesticides which are not safe for use in households and other sensitive areas, or in lieu of pesticidal compositions containing individual plant essential oils. It will also be appreciated by the skilled artisan that the pesticidal compositions of the present invention provide affordable pesticidal formulations that are aesthetically or aromatically acceptable. It will also be appreciated by the skilled artisan that the pesticidal compositions of the present invention unexpectedly exhibit excellent pesticidal activities, specifically knockdown and mortality, using water-based emulsions in both pressurized (e.g., an aerosol) and non-pressurized systems in lieu of oil based solvent systems.

Without wishing to be bound by the following theories, it is believed that plant essential oils attack a pest's nervous system or may act as Phase I and/or Phase II drug metabolizing enzyme inhibitors. In the presence of a synergist, it is believed that the exoskeleton and/or waxy cuticle of a pest is/are more easily penetrated by the pesticidaily active plant essential oil(s) such that less amounts of active material are required to achieve knockdown and kill, thereby reducing exposure levels.

Target pests include all invertebrate pests (e.g., flying and crawling types), including, but not limited to, round worms (e.g., hookworm, trichina, ascaris); flatworms (e.g., liver flukes and tapeworms); jointed worms (e.g., leeches); molluscs (e.g., parasitic snails); and arthropods (insects, spiders, centipedes, millipedes, crustaceans (e.g., barnacles)). In particular, included among the arthropods are ticks; mites (both plant and animal); lepidoptera (butterflies and moths and their larvae); hemiptera (bugs); homoptera(aphids, scales); and coleoptera (beetles). Also included are spiders; anoplura (lice); diptera (flies and mosquitoes); trichoptera; orthoptera (e.g., roaches); odonta; thysanura (e.g., silverfish); collembola (e.g., fleas); dermaptera(earwigs); isoptera(termites); ephemerids (mayflies); plecoptera; mallophaga (biting lice); thysanoptera; and siphonaptera(fleas); dictyoptera (roaches); psocoptera (e.g., booklice); and certain hymenoptera(e.g., those whose larva feed on leaves). In another embodiment of the invention, there is provided a method for controlling pests by treating said pests with a GABA receptor modulator in an amount effective to provide pest control, by either pesticidal or pestistatic activity.

In one aspect, the pesticidal compositions may use surfactants as part of the delivery or carrier system. The presence of nonionic, cationic or anionic surfactants, such as, sodium lauryl sulfate, nonyl phenoxypolyoxyethylene and hydrogenated tallow dimethyl benzyl ammonium chloride, can be used as adjuvants. Adjuvants are believed to confer the broad spectrum pesticidal activity on the composition by acting as a wetting, dispersing and/or emulsifying agent that facilitates or aids in the spreading of the active ingredient across an insect or larva, providing for a more uniform and rapid penetration of the oils through the exoskeleton (if present), thus permitting the oils to exert their pesticidal activity on the internal organs and/or nervous system of the insect or larva. Non-limiting examples of anionic surfactants such as salts of fatty acids, alkyl sulphates, alkyl ether sulphonates and alkyl aryl sulphonates. Other examples of preferred surfactants include sodium dodecyl benzenesulfonic acid, alcohol ethoxylate, olefin sulfonate, and modified phthalic glycerol alkyd resins such as Latron B1956.

In another aspect, the pesticidal compositions of the present invention may act as solvents against the waxy cuticle protecting invertebrate pests, thereby penetrating the cuticle and causing fast knockdown and mortality. The plant essential oils may penetrate the cuticle and contact the nerve endings in the invertebrate pest's trachea, and cause neurotoxic activity. In any event, the net effect of the toxicity and action of the inventive composition disclosed herein is heretofore unknown and unexpected.

Use of pesticidal compositions of the present invention generally results in fast knockdown and 100% mortality on contact. As such, they are advantageously employed as pesticidal agents in uses such as, without limitation, households, lawn and garden applications, agriculture, organic farming, greenhouse/nursery applications, stored product applications, professional pest control, pet bedding, foliage application, underwater or submerged application, solid treatment, soil incorporation application, seedling box treatment, stalk injection and planting treatment, ornamentals, termites, mosquitoes, fire ants, head lice, dust mites, etc. Use of the pesticidal compositions of the present invention generally provides repellency to pests, and as such are advantageously employed as plant protectants.

With respect to soil, the pesticidal compositions resist weathering which includes wash-off caused by rain, decomposition by ultra-violet light, oxidation, or hydrolysis in the presence of moisture or, at least such decomposition, oxidation and hydrolysis as would materially decrease the desirable pesticidal characteristic of the pesticidal compositions or impart undesirable characteristics to the pesticidal compositions. The pesticidal compositions are so chemically inert that they are compatible with substantially any other constituents of pest control, and they may be used in the soil, upon the seeds, or the roots of plants without injuring either the seeds or roots of plants. They may also be used in combination with other pesticidally active compounds.

The pesticidal compositions of the present invention may combined with other materials to make usable formulations that are capable of controlling, knocking down and killing pests readily without causing undue hazards to non-target organisms when applied correctly. As described in further detail below, the pesticidal compositions of the present invention may be applied as technical grade pesticides in ultralow volume (ULV) applications; as dry formulations such as dusts; as wettable powders that may be mixed with water to form suspensions of a desired concentration; and as liquid formulations that may sold as a concentrated solution that end users can dilute with solvent oils to prepare a field-strength solution or an emulsifiable concentrate that can be combined with water to prepare an emulsion.

The pesticidal compositions of the instant invention also typically comprise an inert carrier, in an amount in which the inert carrier can assist the instant active ingredient to be carried through a process or method of controlling pests. As such an amount of the inert carrier, the inventive pesticidal compositions preferably comprise the inert carrier in an amount of from about 5-99.9%, provided that such a carrier is a solid, liquid or gas carrier, or a combination thereof. In such a case, examples of the solid carriers that may be in the pesticidal compositions of the instant invention include clays such as kaolin, diatomaceous earth, bentonite, fubasami clay and terra alba, synthetic hydrated silicon oxides, talc, ceramics, other inorganic minerals which are useful in producing formulated compositions such as sericite, quartz, sulfur, active carbons and calcium carbonate, chemical fertilizers such as ammonium sulfate, ammonium phosphate, ammonium nitrate, urea and ammonium chloride, and the like, as well as powders thereof, granules thereof, and a mixture thereof; examples of the liquid carriers that may be in the pesticidal compositions of the instant invention include water, alcohols such as methanol and ethanol, aromatic hydrocarbons such as toluene, xylene, ethylbenzene and alkyl naphthalenes, non-aromatic hydrocarbons such as hexane, cyclohexane, kerosene, isoparoffinic and normal paroffinic solvents and light oils, esters such as ethyl acetate and butyl acetate, nitrites such as acetonitrile and isobutylonitrile, ethers such as diisopropyl ether and dioxane, amides such as N,N-dimethylformamide and N,N-dimethylacetamide, halogenated hydrocarbons such as dichloromethane, trichloroethane and carbon tetrachloride, dimethylsulfoxide, botanical oils such as soy oil and cotton seed oil, and the like, and a mixture thereof; and examples of the gas carriers that may be in the aerosol form of pesticidal compositions of the instant invention include propellants such as butane gas, propane gas, liquid petroleum gas, dimethyl ether, carbon dioxide, and the like, and a mixture thereof.

In general, any of the materials customarily employed in formulating pesticides, (insecticides, miticides, herbicides, fungicides, etc.) are suitable. The inventive pesticidal compositions of the present invention may be employed alone or in the form of mixtures with such solid and/or liquid dispersible carrier vehicles and/or other known compatible active agents such as other insecticides, acaricides, nematicides, fungicides, bactericides, rodenticides, herbicides, fertilizers, growth-regulating agents, etc., if desired, or in the form of particular dosage preparations for specific application made therefrom, such as solutions, emulsions, suspensions, powders, pastes, and granules which are thus ready for use. The pesticidal compositions of the invention can be formulated or mixed with, if desired, conventional inert pesticide diluents or extenders of the type usable in conventional pesticide formulations or compositions, e.g., conventional pesticide dispersible carrier vehicles such as gases, solutions, emulsions, suspensions, emulsifiable concentrates, spray powders, pastes, soluble powders, dusting agents, granules, foams, pastes, tablets, aerosols, natural and synthetic materials impregnated with active compounds, microcapsules, coating compositions for use on seeds, and formulations used with burning equipment, such as fumigating cartridges, fumigating cans and fumigating coils, as well as ULV cold mist and warm mist formulations, etc. In addition, mineral oil and the essential oils disclosed herein (e.g., safflower oil, benzyl alcohol, citronellal, d-limonene, soybean oil, sesame oil, etc.) may also serve as diluents or carriers in the pesticidal compositions of the present invention.

Suitable means of applying pesticidal compositions of the invention include: to persons or animals infested by or exposed to infestation by arthropods by parenteral, oral or topical application. Examples include incorporation of an active compound in feed or suitable orally-ingestible pharmaceutical formulations, edible baits, salt licks, dietary supplements, pour-on and spot-on formulations, sprays, baths, dips, showers, jets, dusts, greases, shampoos, creams, wax-smears and livestock self-treatment systems; to the environment in general or to specific locations where pests may lurk, including stored products, timber, household goods, and domestic and industrial premises, as sprays, fogs, dusts, smokes, wax-smears, lacquers, granules and baits, and in trickle feeds to waterways, wells, reservoirs and other running or standing water; to domestic animals in feed to control fly larvae feeding in their feces; to growing crops as foliar sprays, dusts, granules, fogs and foams; also as suspensions of finely divided and encapsulated pesticidal compositions of the invention; as soil and root treatments by liquid drenches, dusts, granules, smokes and foams; and as seed dressings by liquid slurries and dusts.

Formulations containing the pesticidal compositions of the present invention may be prepared in any known manner, for instance by extending the pesticidal compositions with conventional liquid carriers and/or dispersible solid carriers optionally with the use of carrier vehicle assistants, e.g., conventional pesticide surface-active agents, including emulsifying agents and/or dispersing agents, whereby, for example, in the case where water is used as diluent, organic solvents may be added as auxiliary solvents. Suitable liquid diluents or carriers include water, petroleum distillates, or other liquid carriers with or without surface active agents. The choice of dispersing and emulsifying agents and the amount employed is dictated by the nature of the composition and the ability of the agent to facilitate the dispersion of the pesticidal compositions of the present invention. Non-ionic, anionic, amphoteric, or cationic dispersing and emulsifying agents may be employed, for example, the condensation products of alkylene oxides with phenol and organic acids, alkyl aryl sulfonates, complex ether alcohols, quarternary ammonium compounds, and the like.

Liquid concentrates may be prepared by dissolving a composition of the present invention with a solvent and dispersing the pesticidal compositions of the present inventions in water with suitable surface active emulsifying and dispersing agents. Examples of conventional carrier vehicles for this purpose include, but are not limited to, aerosol organic solvents, such as aromatic hydrocarbons (e.g., benzene, toluene, xylene, alkyl naphthalenes, etc.), halogenated especially chlorinated, aromatic hydrocarbons (e.g., chloro-benzenes, etc.), cycloalkanes, (e.g., cyclohexane, etc.), paraffins (e.g., petroleum or mineral oil fractions), chlorinated aliphatic hydrocarbons (e.g., methylene chloride, chloroethylenes, etc.), alcohols (e.g., methanol, ethanol, propanol, butanol, glycol, etc.) as well as ethers and esters thereof (e.g., glycol monomethyl ether, etc.), amines (e.g., ethanolamine, etc.), amides (e.g., dimethyl formamide etc.) sulfoxides (e.g., dimethyl sulfoxide, etc.), acetonitrile, ketones (e.g., acetone, methyl ethyl ketone, methyl isobutyl ketone, cyclohexanone, etc.), and water.

Surface-active agents, i.e., conventional carrier vehicle assistants, that may be employed with the present invention include, without limitation, emulsifying agents, such as non-ionic and/or anionic emulsifying agents (e.g., polyethylene oxide esters of fatty acids, polyethylene oxide ethers of fatty alcohols, alkyl sulfates, alkyl sulfonates, aryl sulfonates, albumin hydrolyzates, etc., and especially alkyl arylpolyglycol ethers. In the preparation of wettable powders, dust or granulated formulations, the active ingredient is dispersed in and on an appropriately divided carrier. In the formulation of the wettable powders the aforementioned dispersing agents as well as lignosulfonates can be included. Dusts are admixtures of the compositions with finely divided solids such as talc, attapulgite clay, kieselguhr, pyrophyllite, chalk, diatomaceous earth, vermiculite, calcium phosphates, calcium and magnesium carbonates, sulfur, flours, and other organic and inorganic solids which act as carriers for the pesticide. These finely divided solids preferably have an average particle size of less than about 5 microns. A typical dust formulation useful for controlling insects contains 5 parts of pesticidal composition and 95 parts of diatomaceous earth or vermiculite. Granules may comprise porous or nonporous particles. The granule particles are relatively large, a diameter of about 400-2500 microns typically. The particles are either impregnated or coated with the inventive pesticidal compositions from solution. Granules generally contain 0.05-25%, preferably 0.5-15%, active ingredient as the pesticidally-effective amount. Thus, the contemplated are formulations with solid carriers or diluents such as bentonite, fullers earth, ground natural minerals, such as kaolins, clays, talc, chalk, quartz, attapulgite, montmorillonite or diatomaceous earth, vermiculite, and ground synthetic minerals, such as highly-dispersed silicic acid, alumina and silicates, crushed and fractionated natural rocks such as calcite, marble, pumice, sepiolite and dolomite, as well as synthetic granules of inorganic and organic meals, and granules of organic materials such as sawdust, peanuts, apple pomace, recycled paper, coconut shells, corn cobs and tobacco stalks. Adhesives, such as carboxymethyl cellulose, natural and synthetic polymers, (such as gum arabic, polyvinyl alcohol and polyvinyl acetate), and the like, may also be used in the formulations in the form of powders, granules or emulsifiable concentrations.

Further, the pesticidal compositions of the instant invention may additionally contain a coloring agent, a formulation auxiliary, or a combination thereof. As such, examples of such coloring agents that may be utilized in the pesticidal compositions of the instant invention include inorganic pigments such as metal oxides, titanium oxides and Prussian blue, organic dyes such as alizarine dyes, azo dyes and metallic phthalocyanine dyes, iron, manganese, boron, copper, cobalt, molybdenum, zinc and salts thereof, and the like, or a mixture thereof; and examples of such formulation auxiliaries that may be utilized in the pesticidal compositions of the instant invention include attaching and/or dispersing agents, surfactants, stabilizers, and the like, or a mixture thereof.

If desired, colorants such as inorganic pigments, for example, iron oxide, titanium oxide and Prussian Blue, and organic dyestuffs, such as alizarin dyestuffs, azo dyestuffs or metal phthalocyanine dyestuffs, and trace elements, such as salts of iron, manganese, boron, copper, cobalt, molybdenum and zinc may be used.

In commercial applications, the present invention encompasses carrier composition mixtures in which at least one plant essential oil, as active ingredient, is present in an amount substantially between about 0.01-100% by weight, and preferably 0.5-90% by weight, of the mixture, whereas carrier composition mixtures suitable for direct application or field application generally contemplate those in which the active compound is present in an amount substantially between about 0.0001-10%, preferably 0.01-2%, by weight of the mixture. Thus, the present invention contemplates over-all formulations that comprise mixtures of a conventional dispersible carrier vehicle such as (1) a dispersible inert finely divided carrier solid, and/or (2) a dispersible carrier liquid such as an inert organic solvent and/or water, preferably including a surface-active effective amount of a carrier vehicle assistant, e.g., a surface-active agent, such as an emulsifying agent and/or a dispersing agent, and an amount of the active ingredient which is effective for the purpose in question and which is generally between about 0.0001-100%, and preferably 0.01-95%, by weight of the mixture.

The pesticidal compositions can also be used in accordance with so-called ultra-low-volume process, i.e. by applying such compounds or by applying a liquid composition containing the same, via very effective atomizing equipment, in finely divided form, e.g., average particle diameter of from 50-100 microns, or even less, i.e. mist form, for example by airplane crop spraying techniques. In this process it is possible to use highly concentrated liquid compositions with said liquid carrier vehicles containing from about 20 to 95% by weight of the pesticidal compositions or even the 100% active substances alone, e.g., about 20-100% by weight of the pesticidal compositions. The concentration in the liquid concentrate will usually vary from about 10 to 95 percent by weight. Furthermore, the present invention encompasses methods for killing, combating or controlling invertebrate pests, which comprises applying to at least one of correspondingly (a) such invertebrate pests and (b) the corresponding habitat thereof, i.e. the locus to be protected, e.g., to the household, a correspondingly combative, a pesticidally effective amount, or toxic amount of the particular pesticidal compositions of the invention alone or together with a carrier as noted above. The instant formulations or compositions may be applied in any suitable usual manner, for instance by spraying, atomizing, vaporizing, scattering, dusting, watering, squirting, sprinkling, pouring, fumigating, and the like. The method for controlling invertebrate pests such as cockroaches and ants comprises applying the inventive composition, ordinarily in a formulation of one of the aforementioned types, to a locus or area to be protected from the cockroaches and/or ants, such as the household. The compound, of course, is applied in an amount sufficient to effect the desired action. This dosage is dependent upon many factors, including the targeted pest, the carrier employed, the method and conditions of the application, whether the formulation is present at the locus in the form of an aerosol, or as a film, or as discrete particles, the thickness of film or size of particles, and the like. Proper consideration and resolution of these factors to provide the necessary dosage of the active compound at the locus to be protected are within the skill of those versed in the art. In general, however, the effective dosage of the compound of this invention at the locus to be protected, i.e., the dosage with which the pest comes in contact—is of the order of about 0.001 to about 5.0% based on the total weight of the formulation, though under some circumstances the effective concentration will be as little as 0.0001% or as much as 20%, on the same basis.

The pesticidal compositions and methods of the present invention are effective in the control of different species of invertebrate pests and it will be understood that the pests exemplified and evaluated in the working Examples herein is representative of such a wider variety. By way of example, but not limitation, the pesticidal compositions of the present invention are also useful for control of pests such as fleas, flies, mosquitoes, noseeums, bees (such as yellow jackets), hornets and wasps, cockroaches including the American and German cockroach, termites, houseflies and silverleaf whiteflies (Besimsai argentifolii), leaf hoppers such as the grape or potato leafhoppers (Cicidellidae), cabbage looper (Lepidoptera), ants such as the pharaoh ant, argentine ant, carpenter ant and fire ant, stink or lygus bugs, leafminers (Liriomyza trifollii), western flower thrips (Frankliniella occidentalis) and sucking or chewing insects such as thrips and aphids such as melon aphids (Aphis gossypii), black bean aphids (Aphis fabae); arachnids such as spiders, ticks and plant mites, including two-spotted spider mites (Tetronmychua urticae), McDaniel mites, Pacific mites and European mites; gastropods such as slugs and snails; fungi such as powdery mildew including cladosporium, strawberry powdery mildew, rusts, botrytis, ergots, blight, downy mildew, eutypa, leaf spot, smut, Chytridimycota, Zygomycota, Asomycota, ringworm, rhizopus, rhizoctonia, pythium and erwinia; nematodes; and bacteria. Further targeted pests controlled by the pesticidal composition are, for example, the pillbugs and Isopoda (sowbugs) such as Oniscus asellus, Armadillidium vulgare (Latreille pillbug) and Porcellio scarber, Pieris rapae crucivora (common cabbageworm), Spodoptera litura (tobaccocutworm), Thrips palmi (melon thrips), Empoasca onukii (tea green leafhopper), Phyllonorycter ringoniella (appleleafminer), Lissorhoptrus oryzophilus (rice water weevil), Popillia japonica (Japanese beetle), Phyllotreta (striped flea beetle), Tetranychus kanzawai (Kanzawa spidermite), Polyphagotarsonemus latus (broad mite); Diplopoda such as Blanilus guttulatus (millepede); Chilopoda such as Geophilus carpophagus, Scutigera spp., Scolopendra subspini and Thereunema spp.; Symphyla such as Scutigerella immaculata; Thysanura (bristletails) such as Ctenolepisma villosa (oriental silverfish) and Lepisma saccharina (silverfish); Psocoptera such as Trogium pulsatorium (larger pale booklice); Collembola (snowfleas) such as Onichiurus armatus; Isoptera (termites) such as Mastotermitidae, Termopsidae (e.g., Zootermopsis, Archotermopsis, Hodotermopsis, Porotemes), Kalotermitidae (e.g., Kalotermes, Neotermes, Cryptotermes, Incisitermes, Glyptotermes), Hodotermitidae (e.g., Hodotermes, Microhodotermes, Anacanthotermes), Rhinotermitidae (e.g., Reticulitermes, Heterotermes, Coptotermes, Schedolinotermes), Serritermitidae and Termitidae (e.g., Anitermes, Drepanotermes, Hopitalitermes, Trinervitermes, Macrotermes, Odontotermes, Microtermes, Nasutitermes, Pericapritermes, Anoplotermes); Dictyoptera (cockroaches) such as Blatta orientalis (oriental cockroach), Periplaneta americana (American cockroach), Periplaneta fuliginosa (smokybrown cockroach), Leucophaea maderae and Blattella germanica (German cockroach); Orthoptera such as Gryllotapa spp. (mole cricket), Acheta domesticus, Teleogryllus emma (field cricket), Locusta migratoria (asiatic locust/oriental migratory locust), Melanoplus differentialis and Schistocera gregaria; Dermaptera (earwigs) such as Labidura riparia and Forficula auricularia; Anoplura such as Phthirus pubis, Pediculus humanus, Haematopinus sulus, Linognathus spp. and Solenopotes spp.; Mallophaga such as Trichodectes spp., Tromenopon spp., Bovicola spp. and Felicola spp.; Thysanoptera (thrips) such as Frankiniella intonsa (flower thrips), onion thrips, Thrips tabaci (cotton seedling thrips) and Thrips palmi; Heteroptera such as Nezara spp., Eurygaster spp., Dysdercus intermedius, Cimex lectularis, Triatoma spp., Rhodnius prolixus, Nezara antennata (green stink bug) and Cletus puncttiger; Homoptera such as Aleurocanthus spiniferus (citrus spiny whitefly), Bemisia tabaci (sweetpotato whitefly), Trialeurodes vaporariorum (greenhouse whitefly), cotton asphid, Aphis gossypii (melon aphid), Brtevicoryne brassicae (cabbage asphid), Cryptomyzus ribis, Aphis fabae, Macrosiphum euphorbiae (potato aphid), Myzus persicae (green peach aphid), Phorodon humuli, Empoasca spp., Nephootettix cincticeps (green rice leafhopper), Lecanium corni (brown scale), Saissetia oleae (black scale), Laodelphax striatellus (small brown plant hopper), Nilaparvata lugens (brown rice planthopper), Aonidiella aurantii (red scale), Aspidiotus hederae (ivy scale), Pseudococcus spp., Psylla spp. and Phylloxera vastrix; Lepidoptera such as Pectinophora gossypiella (pink bollworm), Lithocolletis blancardella, Plutella xyloste (diamondback moth), Malacosoma neustria (tent caterpillar), Euproctis subflava (oriental tussock moth), Lymantria dispar (gypsy moth), Bucculatrix pyrivorella (pear leafminer), Phyllocnistis citrella (citrus leafminer), Agrotis spp., Euxoa spp., Earias insulana, Heliothis spp., Spodoptera exigua (beet armyworm), Spodoptera litura (common cutworm), Spodoptera spp., Mamestra brassicae (cabbage armyworm), Trichoplusia ni, Carpocapsa pomonella, Pieris spp., Chilo spp., Pyrausta nubilalis, Ephestia kuehniella (Mediterranean flour moth), Galleria mellonella (greater wax moth), Tineola bisselliella (webbing clothes moth), Tenea translucens, oriental tea tortrix (Homona magnanima) and Totrix viridana; Coleoptera (beetles) such as Anobium punctatum, Rhizopertha dominica (lesser grain borer), Acanthoscelides obectus (bean weevil), Agelastica alni, Leptinotarsa decemlineata, Phaedon cochleariae, Diabrotica spp., Psylliodes angusticollis (solanum flea beetle), Phyllotreta striolata (striped flea beetle), Epilachna spp., Atomaria spp., Oryzaephilus surinamensis (sawtoothed grain beetle), Anthonomus spp., sitophilus spp., Otriorhynchus sulcatus (black vine weevil), Cosmopolites sordidus (banana weevil borer), Ceuthorhyncidius albosuturalis, Hypera postica (alfalfa weevil), Dermestes spp., Trogoderma spp., Attagenus unicolor (black carpet beetle), Lyctus spp., Meligethes aeneus, Ptinus spp., Gibbium psylloides, Tribolium spp., Tenebrio molitor (yellow mealworm), Agriotes spp., Melolontha mololontha, Scolytidae (e.g., Xyleborus and Scolytoplatypus), Cerambycidae (e.g., Monochamus, Hylotrupes, Hesperophanus, Chlorophorus, Palaeocallidium, Semanotus, Purpuricenus, Stromatium), Platypodidae (e.g., Crossotarsus, Platypus), Bostrychidae (e.g., Dinoderus, Bostrychus, Sinoderus), Anobiidae (e.g., Ernobius, Anobium, Xyletinus, Xestobium, Ptilinus, Nicobium, Ptilneurus) and Buprestidae; Hymenoptera such as Diprion spp., Hoplocampa spp., Lasius spp., Formica japonica, Vespa spp., and Siricidae (e.g., Urocerus, Sirex); Diptera such as Aedes spp., Anopheles spp., Culex spp., Drosophila melanogaster, Musca domestica (housefly), Fannia spp., Calliphora spp., Lucilia spp., Chrysomya spp., Cuterebra spp., Gastrophilus spp., Stomoxys spp., Oestrus spp., Hypoderma spp., Tabanus spp., Bibio hortulanus, Pegomyia hyoscyami, Ceratitus capitata, Dacus dorsalis (oriental fruit fly), Tipula paludosa, Simulium spp., Eusimulium spp., Phlebotomus spp., Culicoides spp., Chrysops spp., Haematopota spp., Braula spp., Morellia spp., Glossina spp., Wohlfahrtia spp., Sarcophaga spp., Lipoptena spp., Melophagus spp. and Muscina spp.; Siphonaptera such as Xenopsylla cheopis, Ceratophyllus spp., Pulex spp. (human flea) and Ctenocephalides spp. (cat flea/dog flea); Arachnida such as Scorpio maurus, Latrodectus mactans and Chiracanthium spp.; mites such as Otodectus spp., Acarus siro (grain mite), Argas spp., Ornithodoros spp., Ornithonyssus spp., Dermanyssus spp., Eriophyes spp., Chelacaropsis moorei, Dermatophagoides spp., Psoroptes equi, Chorioptes spp., Saracoptes spp., Tarsonemus spp., clover mite (Bryobia praetiosa), Panonychus spp., Tetranychus spp. (spider mites), Raillietas spp., Pneumonyssus spp., Sternostorma spp., Acarapis spp., Cheyletiella spp., Myobia spp., Psorergates spp., Demodex spp., Trombicula spp., Listrophorus spp., Tyrophagus spp., Sarcoptes spp., Notoedres spp., Cytodides spp., Laminosioptes spp.; and the like.

While the composition of the present invention has the excellent pesticidal activities against various species of pests, it shows particularly favorable efficacy for control of vector or nuisance pests including cockroaches such as German cockroach (Blattella germanica), smokybrown cockroach (Periplaneta fuliqinosa), American cockroach (Periplaneta americana), brown cockroach (Periplaneta brunnea) and oriental cockroach (Blatta orientalis), house mites such as mold mite (Tyrophagus putrescentiae), American house dust mite (Dermatophagoides farinae) and Cheyletid mites (Chelacaropsis), fleas such as cat flea (Ctenocephalides felis), mosquitoes such as brown house mosquito (Culex pipiens pallens) and Asian tiger mosquito (Aedes albopictus), and flies such as housefly (Musca domestica), and wood pests including termites such as Formosan subterranean termite (Copptotermes formosanus), Japanese subterranean termite (Reticulitermes speratus), American common dry-wood termite (Incistermes minor), Daikoku dry-wood termite (Cryptotermes domesticus), Odontotermes formosanus, Coptotermes formosanus, Reticulitermes speratus, R. flavipes, R. hesperus, R. virqinicus, R. tibialis, Incisitermes minor, Cryptotermes domesticus, Odontotermes formosanus, and Heterotermes aureus, termite species of the families (and pest genera) Mastotermitidae (Mastotermes species), Hodotermididae (Anacanthotermes, Zootermopsis species), Rhinotermitidae (Coptotermes, Heterotermes, Reticulitermes, Psammotermes, Prorhinotermes, Schedorhinotermes species ), Kalotermitidae (Glyoptotermes, Neotermes, Cryptotermes, Incisitermes, Kalotermes, Marqinitermes species ), Serritermitidae, and Termitidae (Pericapritermes, Allodontermes, Microtermes, Odontotermes, Nasutitermes, Termes, Amitermes, Globitermes, Microcerotermes species), Termopsidae (Hodotermopsis, Zootermopsis species), and other pest species of termites, raw logvermin such as bark beetles (Scolytidae), longicorn beetles (Cerambycidae), weevils (Curculionidae), pinhole borers (Platypodidae) and horntails (Siricidae), and dry wood vermin such as powderpost beetle (Lyctus brunneus), false powderpost beetles (Bostrychidae), deathwatch and drugstore beetles (Anobiidae) and dry-wooden longicorn beetle (Stromatium longicorne).

An exemplary method for controlling pests comprises applying (such as by spraying) to a pest or site of pest infestation, a pesticidally effective amount of a pesticidal composition in an amount sufficient to prevent infestation of the host and the composition does not damage the host's tissue. Of particular interest is use of the pesticide compositions of the invention in treating fungal infestations of fruit bearing plants such as strawberry plants. By treatment of a diseased plant with the composition of the invention in an amount sufficient to treat such a fungal infestation, pests such as powdery mildew can be controlled or eliminated, thus restoring the plant to a healthy state. Also of particular interest is use of the pesticide compositions of the invention in controlling arthropod infestations of ornamental plants such as roses. By treatment of a diseased plant with the composition of the invention in an amount sufficient to treat such a arthropod infestation, pests such as aphids and spider mites can be controlled or eliminated, thus restoring the plant to a healthy state.

Use of pesticides is regulated in the United States by the Environmental Protection Agency (EPA) under authority of the Federal Insecticide, Fungicide and Rodenticide Act (FIFRA). Tolerance for residues of pesticides in agricultural commodities are established by the (EPA) and enforced by the Food and Drug Administration (FDA) under authority of the Federal Food, Drug and Cosmetic Act (FD&C Act). This regulatory environment leads to another aspect of this invention, which is an article of manufacture. In this aspect a pesticidally active composition of the exemplary embodiments are sold in a container that will be suitable for storing the composition for its shelf life. Associated with the container is printed instructions and/or a printed label indicating that the subject composition can be used to control pests, i.e., used as a pesticide and providing instructions for using the composition for pesticidal purposes in accordance with the treatment method set forth herein. The container may have associated with it a delivery device that allows the composition to be applied to the pest population or to the area to be treated. For liquid compositions this is generally a hand-operated, motorized or pressurized pressure-driven sprayer. The container may be made of any suitable material such as a polymer, glass, metal, or the like. Usually, the labeling is associated with the container by being adhered to the container, or accompanying the container in a package sold to the user. Such label may indicate that the composition is approved for use as a pesticide. The instructions will spell out the type of pests for which the pesticidal composition is to be used, the application method, the rate of application, dilution requirements, use precautions, and the like.

The efficacy of the pesticidal compositions of the present invention may be monitored by determining the mortality of or damage to the pest population, i.e., by determining its adverse effect upon treated pests. This includes damage to the pests, inhibition or modulation of pest growth, inhibition of pest reproduction by slowing or arresting its proliferation, or complete destruction/death of the pest, all of which are encompassed by the term “controlling”. The term “pesticidally effective amount” is an amount of the compound of the invention, or a composition containing the compound, that has an adverse affect on at least 25% of the pests treated, more preferably at least 50%, most preferably at least 70% or greater. Preferably, an “effective pest-inhibiting amount” is an amount of the compound of the invention, or a composition containing the compound, where 25% or greater mortality against pests is achieved, preferably 50% or greater, more preferably 70% or greater mortality. Similarly, an “effective pest-growth modulating amount” is preferably one where 25% or greater pest-growth modulation is achieved, preferably 50% or greater, more preferably 70% of greater. The term “amount sufficient to prevent infestation” is also used herein and is intended to mean an amount that is sufficient to deter all but an insignificant sized pest population so that a disease or infected state is prevented. The actual value of a pesticidally effective amount for a given compound is preferably determined by routine screening procedures employed to evaluate pesticidal activity and efficacy, such as are well known by those skilled in the art and as are described in the Examples. It is expected that compounds of the invention having a higher level of pesticidal activity can be used in smaller amounts and concentrations, while those having a lower level of activity may require larger amounts or concentrations in order to achieve the same pesticidal effect. Efficacy is also monitored by phytotoxicity to the plants that are infested with the pest population, tissue damage to the host infected with the pest population and any adverse effects that might be experienced by a human user who is applying the composition to an infested plant or animal. Accordingly, the amount of composition or active compound used in the methods of the invention, meets the mortality, modulation or prevention criteria above, and preferably has minimal or no adverse effect on ornamental and agricultural plants (such as phytotoxicity), wildlife and humans that may come into contact with such compound.

The composition and method of the present invention will be further illustrated in the following, non-limiting Example(s). The Example(s) are illustrative of various embodiments only and do not limit the claimed invention regarding the materials, conditions, weight ratios, process parameters, ranges and the like recited herein.

### Example 1

[³H]-TBOB Assay. In this study, five monoterpenoids (Pulegone, Thymol, Alpha-terpineol, Linalool and Carvacrol) were investigated to determine their modulation effects on [³H]TBOB (t-butylbicycloorthobenzoate) binding to housefly GABA (Gamma-aminobutyric acid) receptors.

Materials and Methods

Materials:

The five monoterpenoids (pulegone, thymol, alpha-terpineol, linalool and carvacrol) were purchased from Sigma-Aldrich Chemical Co., as was the picrotoxin. The [³H]-TBOB was purchased from Amersham Biosciences.

Tissue Preparation:

House fly heads (200) were homogenized in 10 mM tris-HCL buffer (pH 7.5) containing 0.25M sucrose (buffer A) with a glass homogenizer. The homogenate was centrifuged at 1,000×g for 5 minutes. The supernatant was filtered by four layers cheesecloth and centrifuged at 25,000×g for 30 minutes. The supernatant was discarded, and the pellet was homogenized and resuspended in buffer A for 30 minutes. The suspension was centrifuged at 25,000×g for 30 minutes. The final pellet was suspended in 10 mM phosphate buffer (pH 7.5) containing 300 mM NaCL (buffer B) and used directly for the assays.

[³H]-TBOB Binding Assay

100 μl membrane was incubated for 70 minutes at room temperature with 4 nM [³H]-TBOB, different amounts of candidate inhibitor and buffer B. The total assay buffer volume was 500 μl. After incubation, samples were filtered by glass fiber filter papers and washed with 5 ml ice-cold buffer B 3 times. Radioactivity was measured by liquid scintillation counter. Specific binding was calculated as the difference between the total ³H bound and nonspecific ³H bound with 100 μM picrotoxin.

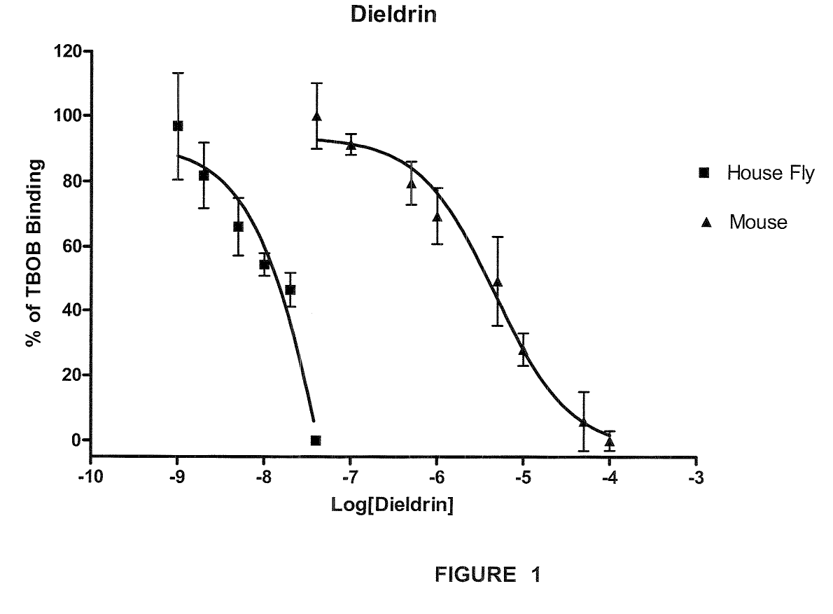

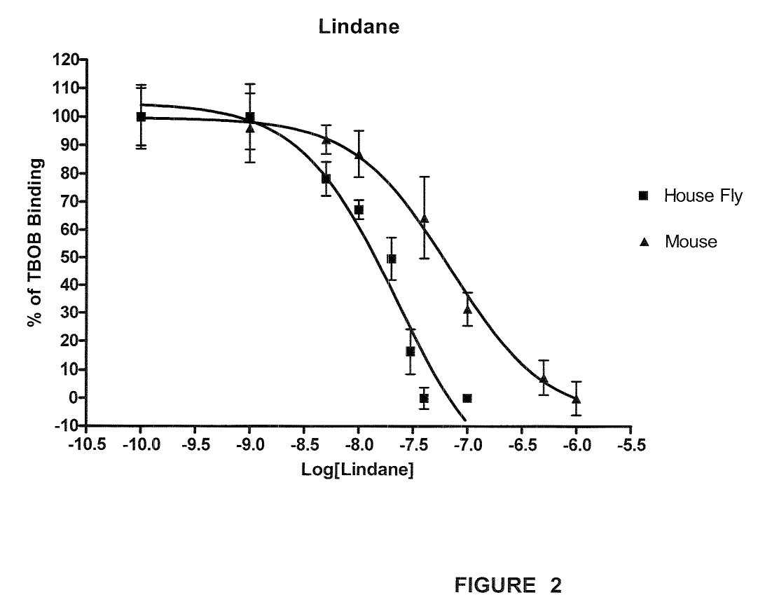

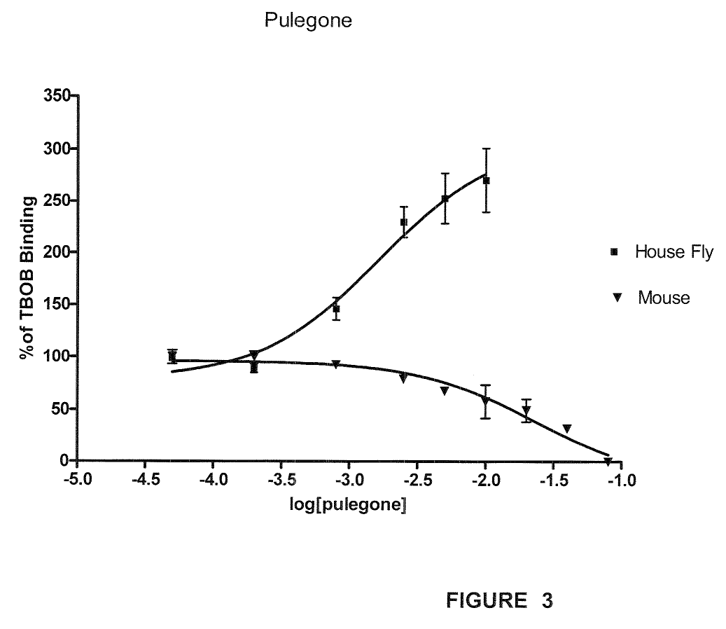

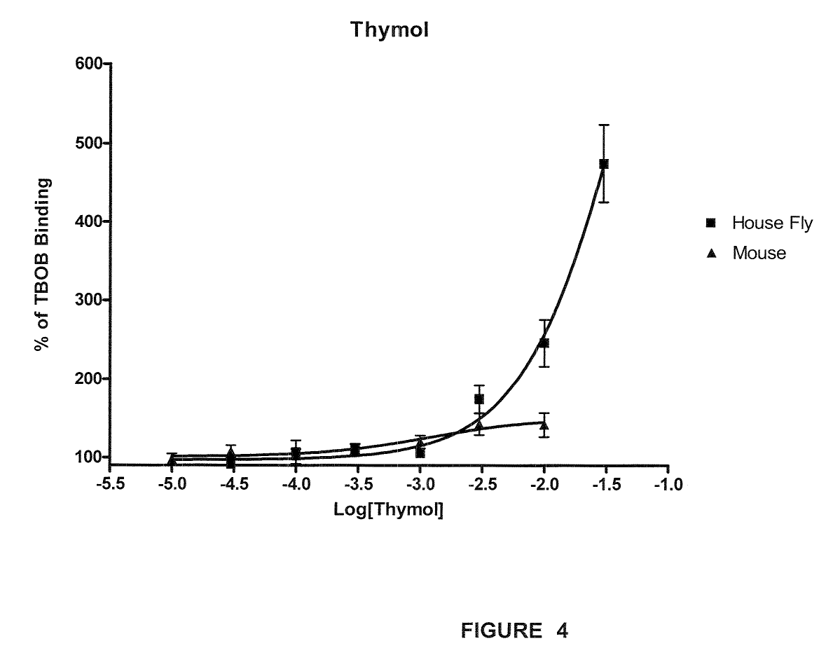

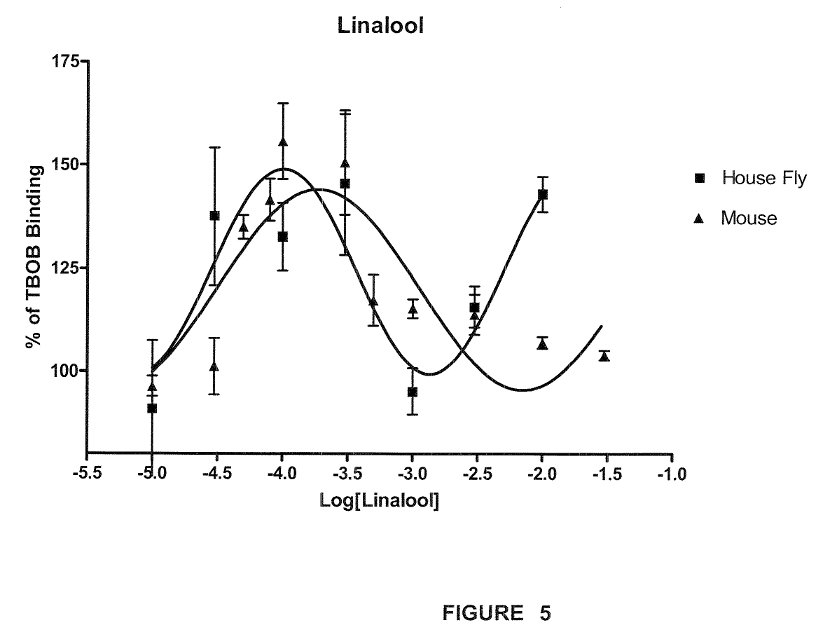

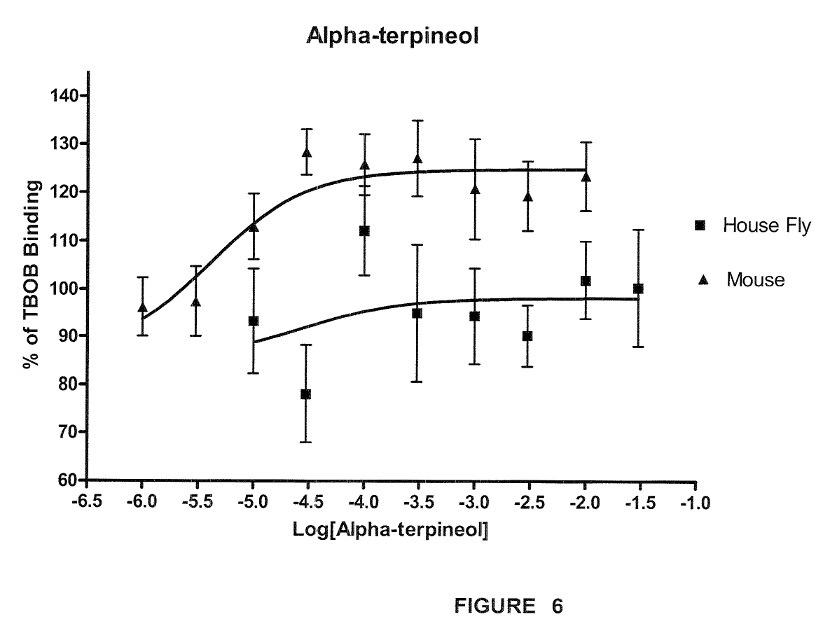

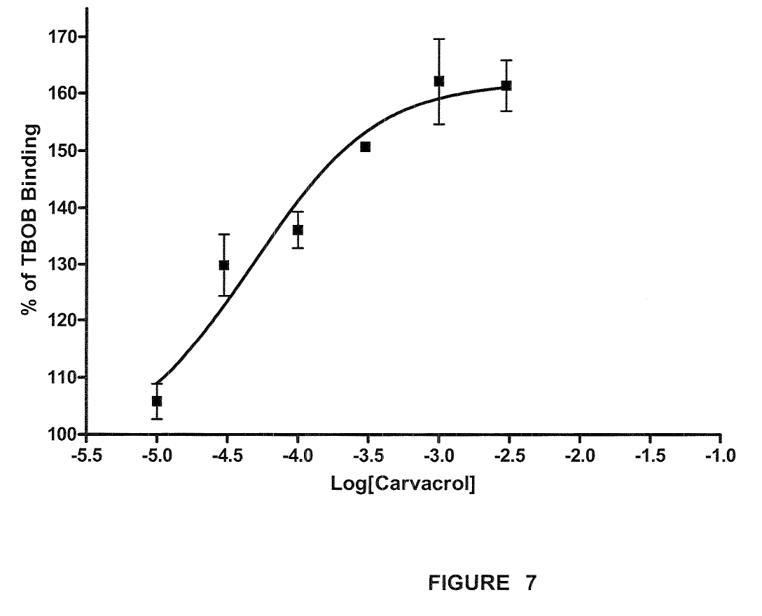

FIGS. 1-7 show that five monoterpenoids (pulegone, thymol, alpha-terpineol, linalool, and carvacrol) modulated the house fly GABA receptor based on the [³H]-TBOB—house fly GABA receptor binding assay. From the data of binding assays, alpha-terpineol showed lesser effects on [³H]-TBOB binding activity, while pulegone, thymol, carvacrol, and linalool potentiated the binding of [³H]-TBOB to house fly GABA receptor, which indicated an interaction between house fly GABA receptor and the monoterpenoids. The binding site is different from the TBOB binding site (also known as the PTX binding site), but there is clearly an important disruptive effect in the house fly nervous system.

### Example 2

### ³⁶Cl— Uptake Assay

Cockroach CNS Membrane Microsacs Preparation: Thoracic and abdominal ganglia were removed from 30 American cockroaches and homogenized in 8.0 ml ice-cold buffer of the following composition (in millimoles per liter): NaBr, 145; KBr, 5.0; MgSO₄, 1.0; Ca(NO₃)₂, 1.0; D-glucose, 10.0; N-2-hydroxyethylpiperazine-N′-2-ethanesulphonic acid (HEPES), 10.0 (adjusted to pH 7.5). The homogenate was centrifuged in 1.0 ml aliquots at 10,000×g for 20 min, and the pellets were re-suspended in buffer, re-centrifuged and finally re-suspended in buffer for assaying GABA-activated ³⁶Cl— uptake.

Cockroach GABA-activated ³⁶Cl— Uptake: Aliquots (200 μl) of this microsac preparation were incubated at 30° C. for 3 min after which 150 μl of a solution of ³⁶Cl— (0.2 μCi ml-l; specific activity 580 μCi mmol⁻¹) containing 1 μM GABA was added. Candidate monoterpenoids were incubated with the tissue sample for 3 min before addition of the solution containing ³⁶Cl— and GABA. To stop the influx of 36CL—, 2.0 m1 of ice cold buffer was added (after 10 s) and the solution was rapidly filtered over a glass-fiber filter (Whatman GF/C) followed by a 10-ml wash with ice-cold buffer. Filters, which then contained the microsacs, are placed into scintillation vials, and the scintillation cocktail was added. The vials were counted in the liquid scintillation counter, and the amount of ³⁶Cl— taken up into the microsacs was measured and calculated on the molar basis.

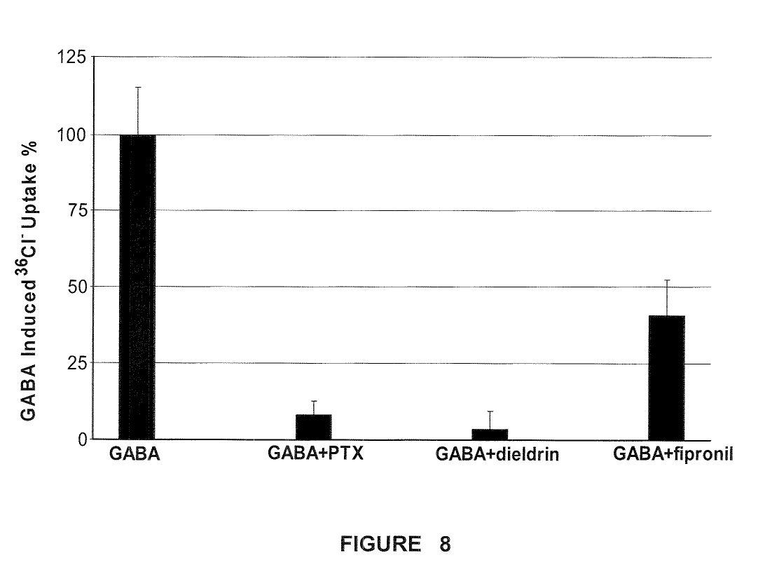

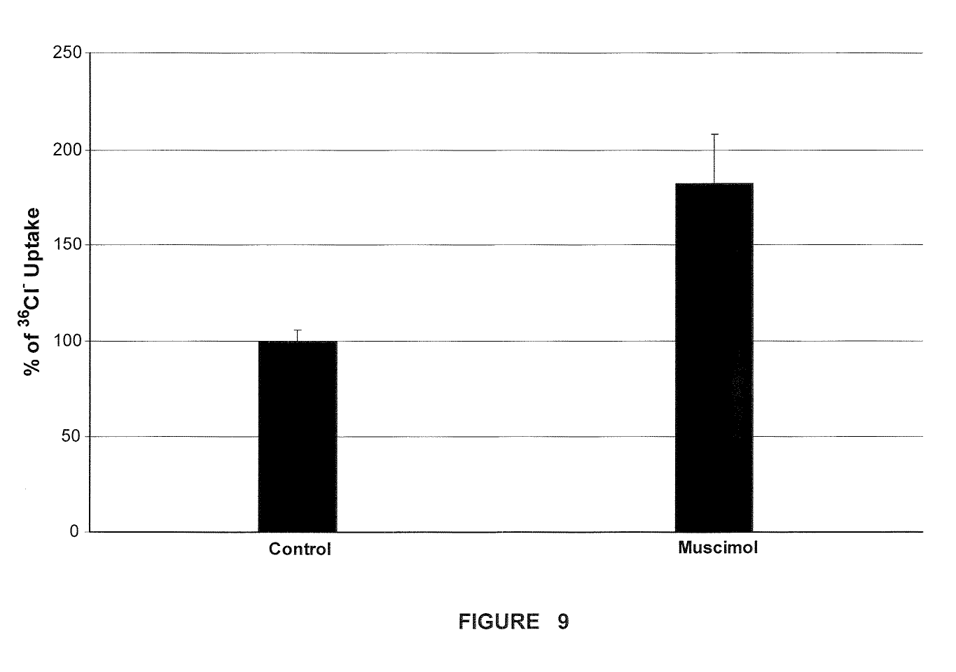

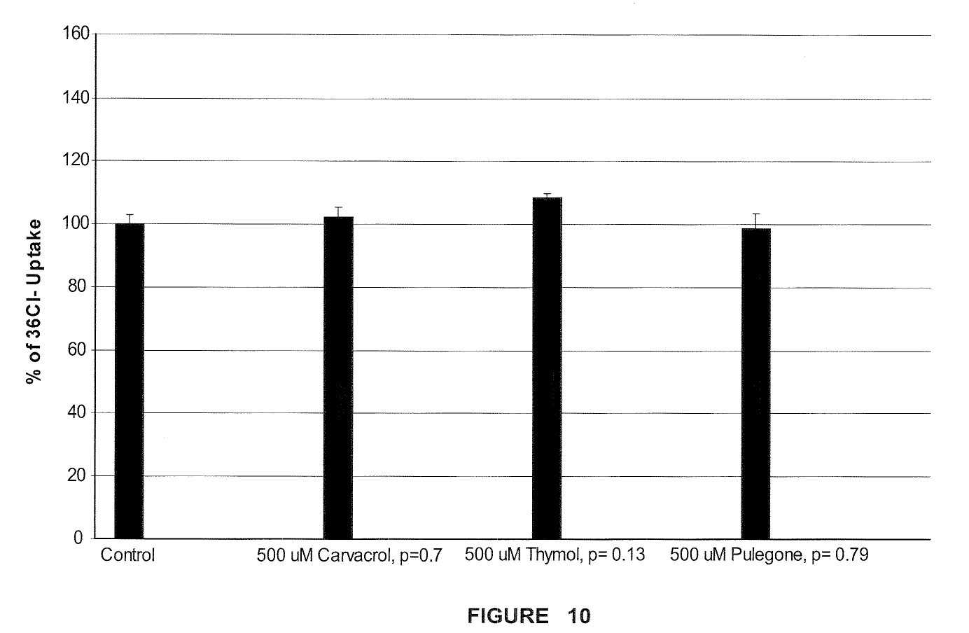

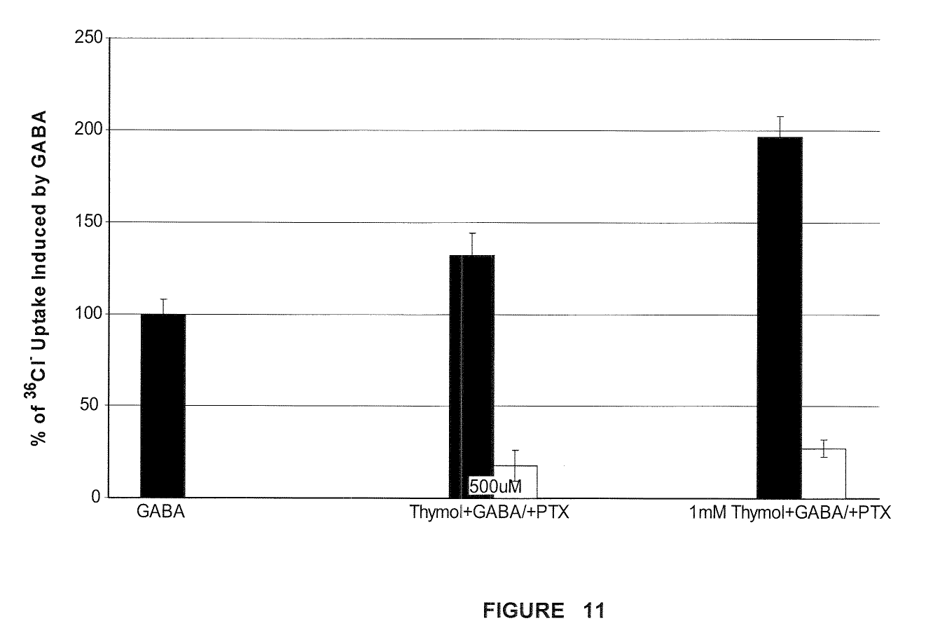

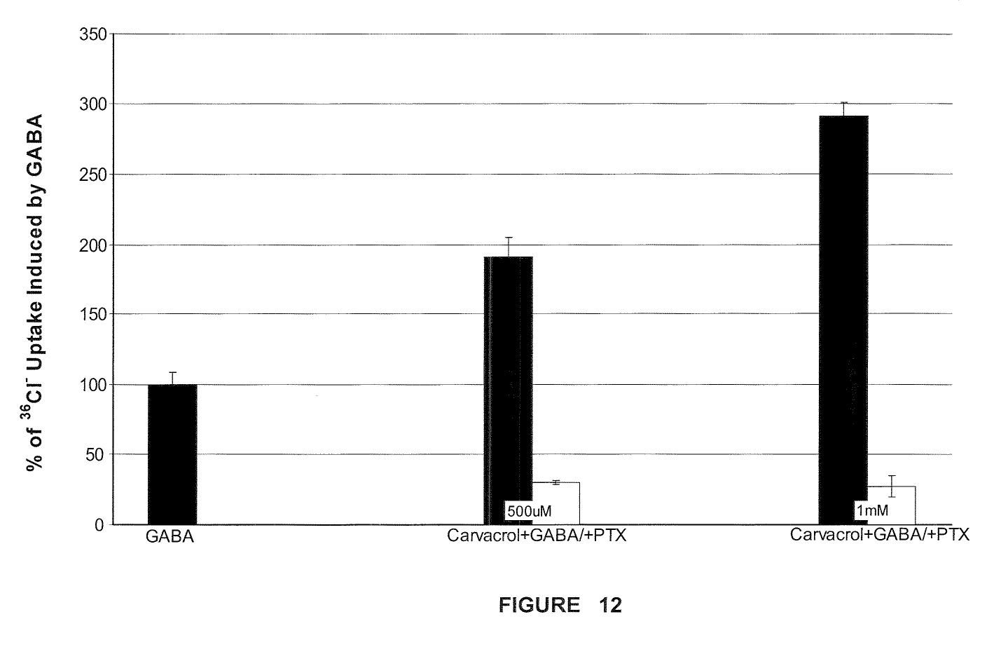

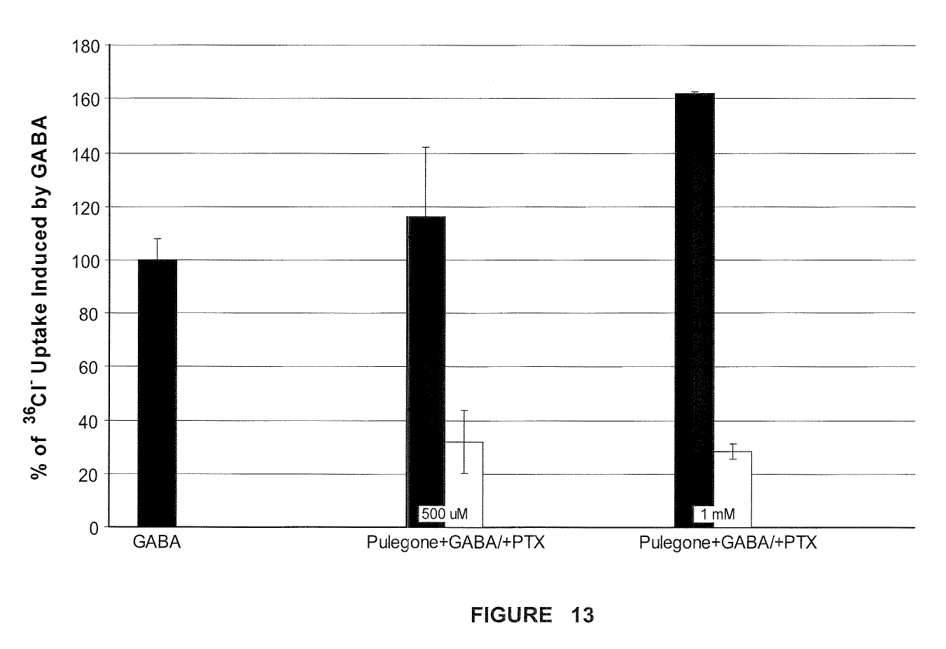

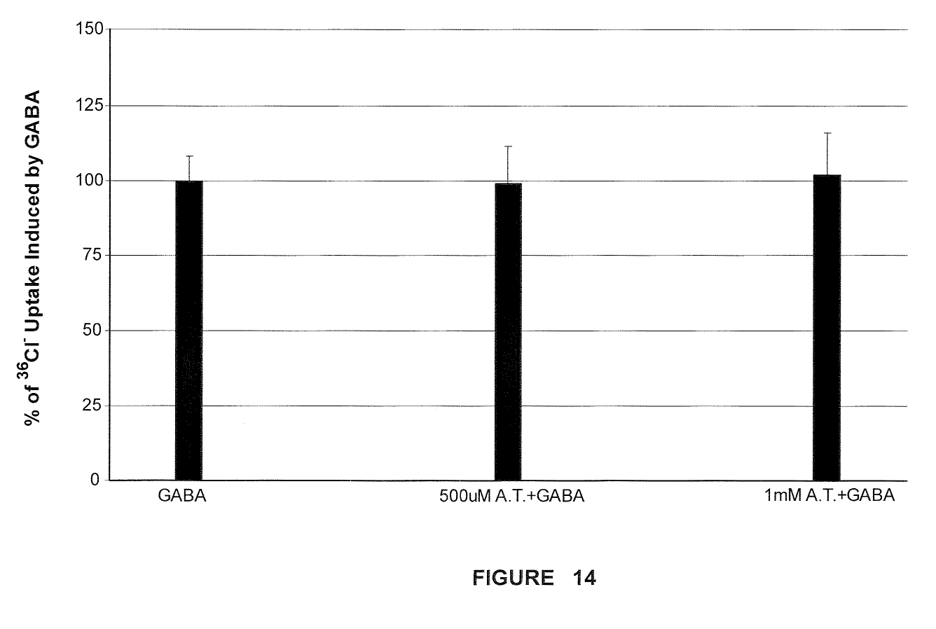

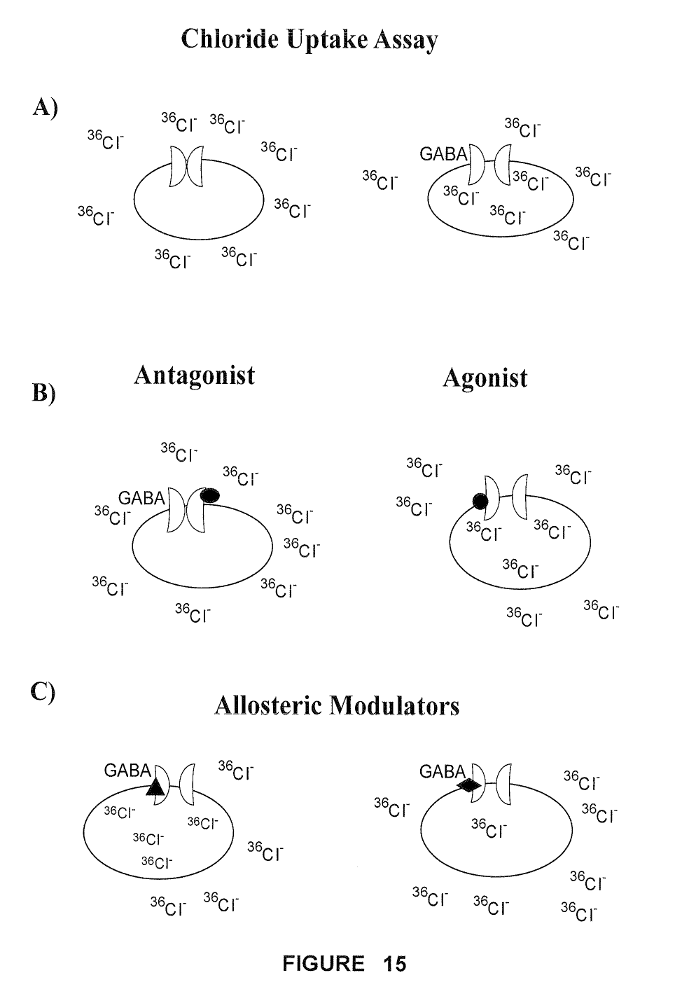

FIGS. 8-15 show that pulegone, thymol, and carvacrol were observed to modulate Cl— uptake in American cockroach membrane microsacs. Results support that both carvacrol and thymol are positive modulators of the insect GABA receptor.

(References: Sattelle, D., Lummis, S., Wong, J., and Rauh, J. Pharmacology of insect GABA receptors Neurochemical Research, 1991, 16(3), 363-374; and Wafford, K., Sattelle, D., Abalis, I., Eldefrawi, A., and Eldefrawi, M. γ-Aminobutyric acid-activated ³⁶CL⁻ influx: a functional in vitro assay for CNS γ-aminobutyric acid receptors of insects. Journal of Neurochemistry, 1987, 48(1), 177-180

These data demonstrate unexpected and superior efficacy of the exemplified embodiments in terms of both knockdown and mortality.

As can be seen from the above discussion, the pesticidal combinations of active compounds and methods according to the present invention are markedly superior to known pesticidal agents/active compounds conventionally used for control of pests. Although illustrative embodiments of the invention have been described in detail, it is to be understood that the exemplary embodiments are not limited to those precise embodiments, and that various changes and modifications can be effected therein by one skilled in the art without departing from the scope and spirit of the invention as defined herein.

What is claimed is:

1. A method for interacting with the neurotransmitters of GABA receptor sites in a pest to thereby kill and/or affect the feeding habits and/or growth of the pest without similarly affecting mammals, fish or fowl, the method comprising:
selecting at least one affector agent based on the ability of the affector agent to interact or modulate the GABA receptor sites in the pest, the affector agent comprising at least one GABA receptor modulator;
applying to the pest or their habitat, a pesticidal composition comprising a pesticidally-acceptable carrier and said at least one affector agent,
wherein the affector agent is present in the pesticidal composition in a pesticidally-effective amount to modulate the GABA receptor sites to kill or affect the feeding and/or growth of the pest without being harmful to mammals, fish or fowl.

2. The method of claim 1, wherein the GABA receptor modulator is a member selected from the group consisting of: α-pinene, β-pinene; α-campholenic aldehyde; α-citronellol; α-iso-amyl-cinnamic (e.g., amyl cinnamic aldehyde); α-pinene oxide; α-cinnamic terpinene; α-terpineol (e.g., 1-methyl-4-isopropyl-1-cyclohexen-8-ol); λ-terpinene; achillea; aldehyde C16 (pure); alpha-phellandrene; amyl cinnamic aldehyde; amyl salicylate; anethole; anise; aniseed; anisic aldehyde; basil; bay; benzyl acetate; benzyl alcohol; bergamot (e.g., Monardia fistulosa, Monarda didyma, Citrus bergamia, Monarda punctata); bitter orange peel; black pepper; white pepper; borneol; calamus; camphor; cananga oil (e.g., java); cardamom; carnation (e.g., dianthus caryophyllus); carvacrol; carveol; cassia; castor; cedar (e.g., hinoki); cedarwood; chamomile; cineole; cinnamaldehyde; cinnamic alcohol; cinnamon; cis-pinane; citral (e.g., 3,7-dimethyl-2,6-octadienal); citronella; citronellal; citronellol dextro (e.g., 3,7-dimethyl-6-octen-1-ol); citronellol; citronellyl acetate; citronellyl nitrile; citrus unshiu; clary sage; clove (e.g., eugenia caryophyllus); clove bud; coriander; corn; cotton seed; 6-tent-butyl-m-cresol; d-dihydrocarvone; decyl aldehyde; diethyl phthalate; dihydroanethole; dihydrocarveol; dihydrocarvacrol; dihydrolinalool; dihydromyrcene; dihydromyrcenol; dihydromyrcenyl acetate; dihydroterpineol; dimethyl salicylate; dimethyloctanal; dimethyloctanol; dimethyloctanyl acetate; diphenyl oxide; dipropylene glycol; d-limonene; d-pulegone; estragole; ethyl vanillin (e.g., 3-ethoxy-4-hydrobenzaldehyde); eucalyptol (e.g., cineole); eucalyptus citriodora; eucalyptus globulus; eucalyptus; eugenol (e.g., 2-methoxy-4-allyl phenol); evening primrose; fenchol; fennel; Feniol™ (phenethyl alcohol and caprylyl glycol); fish oil; florazon (e.g., 4-ethyl-α,α-dimethyl-benzenepropanal); galaxolide; geraniol (e.g., 2-trans-3,7-dimethyl-2,6-octadien-8-ol); geraniol; geranium; geranyl acetate; geranyl nitrile; ginger; grapefruit; guaiacol; guaiacwood; gurjun balsam; heliotropin; herbanate (e.g., 3-(1-methyl-ethyl)bicyclo(2,2,1) hept-5-ene-2-carboxylic acid ethyl ester); hiba; hydroxycitronellal; i-carvone; i-methyl acetate; ionone; isobutyl quinoleine (e.g., 6-secondary butyl quinoline); isobornyl acetate; isobornyl methylether; isoeugenol; isolongifolene; jasmine; jojoba; juniper berry; lavender; lavandin; lemon grass; lemon; lime; limonene; linallol oxide; linallol; linalool; linalyl acetate; linseed; litsea cubeba; l-methyl acetate; longifolene; mandarin; mentha; menthane hydroperoxide; menthol crystals; menthol laevo (e.g., 5-methyl-2-isopropyl cyclohexanol); menthol; menthone laevo (e.g., 4-isopropyl-l-methyl cyclohexan-3-one); methyl anthranilate; methyl cedryl ketone; methyl chavicol; methyl hexyl ether; methyl ionone; mineral; mint; musk ambrette; musk ketone; musk xylol; mustard (also known as allylisothio-cyanate); myrcene; nerol; neryl acetate; nonyl aldehyde; nutmeg (e.g., myristica fragrans); orange (e.g., citrus aurantium dulcis); orris (e.g., iris florentina) root; para-cymene; para-hydroxy phenyl butanone crystals (e.g., 4-(4-hydroxyphenyl)-2-butanone); passion palmarosa oil (e.g., cymbopogon martini); patchouli (e.g., pogostemon cablin); p-cymene; pennyroyal oil; pepper; peppermint (e.g., mentha piperita); perillaldehyde; petitgrain (e.g., citrus aurantium amara); phenyl ethyl alcohol; phenyl ethyl propionate; phenyl ethyl-2-methylbutyrate; pimento berry; pimento leaf; pinane hydroperoxide; pinanol; pine ester; pine needle; pine; pinene; piperonal; piperonyl acetate; piperonyl alcohol; plinol; plinyl acetate; pseudo ionone; rhodinol; rhodinyl acetate; rosalin; rose; rosemary (e.g., rosmarinus officinalis); ryu; sage; sandalwood (e.g., santalum album); sandenol; sassafras; sesame; soybean; spearmint; spice; spike lavender; spirantol; starflower; tangerine; tea seed; tea tree; terpenoid; terpineol; terpinolene; terpinyl acetate; tert-butylcyclohexyl acetate; tetrahydrolinalool; tetrahydrolinalyl acetate; tetrahydromyrcenol; thulasi; thyme; thymol; tomato; trans-2-hexenol; trans-anethole and metabolites thereof; turmeric; turpentine; vanillin (e.g., 4-hydroxy-3-methoxy benzaldehyde); vetiver; vitalizair; white cedar; white grapefruit; and wintergreen (e.g., methyl salicylate).

3. The method of claim 1, wherein the pesticidal composition further comprises a member selected from the group consisting of: from a synergist, stabilizing substance, insecticide, pesticide, acaricide, plant nematicide, anthelmintic, anticoccidial, fungicide, bactericide, antiviral, arthropod attractant, arthropod repellent, arthropod pheromone, vertebrate attractant, vertebrate repellent, vertebrate pheromone, deodorant, flavoring agent, dye, trace element, and vitamin.

4. The method of claim 1, wherein the pesticidal composition further comprises a member selected from the group consisting of: acephate, acetamiprid, acrinathrin, alanycarb, albendazole, aldicarb, alphamethrin, amitraz, avermectins, azadirachtin, azinphos, azocyclotin, Bacillus thuringiensis, bendiocarb, benfuracarb, bensultap, benzoximate, bephenium, betacyfluthrin, bifenazate, bifenthrin, bistrifluoron, BPMC (2-sec-Butylphenyl Methylcarbamate), brofenprox, bromophos, brotianide, bufencarb, buprofezin, butamisole, butocarboxin, butylpyridaben, cadusafos, cambendazole, carbaryl, carbofuran, carbophenothion, carbosulfan, cartap, chloethocarb, chlorfenapyr, chloroethoxyfos, chlorofenvinphos, chlorofluazuron, chloromephos, chlorpyrifos, chromafenozide, cis-resmethrin, clocythrin, clofentezine, clorsulon, closantel, clothianidin, cyanophos, cycloprothrin, cyfluthrin, cyhalothrin, cyhexatin, cypermethrin, cyromazine, deltamethrin, demeton, demeton-S-methyl, diamphenethide, diaveridine, diazinon, dibromosalan, dichlofenthion, dichlorophen, dichlorvos, dicliphos, dicofol, dicrotophos, diethion, diethylcarbamazine, difenthiuron, diflubenzuron, dimethoate, dimethylvinphos, dimetridazole dinotefuran, dioxathion, disulfoton, edifenphos, endosulfan, epsiprantel, esfenvalerate, ethiofencarb, ethion, ethiprole, ethofenprox, ethoprofos, etoxazole, etrimphos, febantel, fenamiphos, fenbendazole, fenbutatin oxide, fenitrothion, fenobucarb, fenothiocarb, fenoxycarb, fenpropathrin, fenpropathrin, fenpyrad, fenpyroximate, fenthion, fenvalerate, fenzaquin, fipronil, flonicamid, fluazinam, fluazuron, flubendazole, flucycloxuron, flucythrinate, flufenoxuron, flufenprox, fluvalinate, fonophos, formothion, fosthiazate, fubfenprox, furathiocarb, gamma-cyhalothrin, haloxon, heptenophos, hexachlorophene, hexaflumuron, hexythiazox, imidacloprid, indoxacarb, iprobenfos, isazophos, isofenphos, isoprocarb, isoxathion, ivermectin, lambda-cyhalothrin, levamisole, lindane, lufenuron, malathion, mebendazole, mecarbam, mesulfenphos, metaldehyde, methacrifos, methamidophos, methidathion, methiocarb, methomyl, methoxyfenozide, methyridine, metolcarb, mevinphos, milbemectin, milbemycins, monocrotophos, morantel, naled, netobimin, niclopholan, niclosamide, nitenpyram, nitroxynil, omethoate, oxamyl, oxfendazole, oxibendazole, oxyclozanide, oxydemethon M, oxydeprofos, parathion A, parathion M, parathion, parbendazol, permethrin, phenothiazine, phenthoate, phorate, phosalone, phosmet, phosphamidon, phoxim, pirimicarb, pirimiphos, praziquantel, profenofos, promecarb, propaphos, propoxur, prothiofos, prothoate, pymetrozin, pyrachlophos, pyrantel, pyresmethrin, pyrethrum, pyridaben, pyridaphenthion, pyrimidifen, pyriproxifen, quinalphos, rafoxanide, rynaxypyr, salithion, sebufos, silafluofen, spirodiclofen, spirotetratmat, sulfotep, sulprofos, tebufenozid, tebufenpyrad, tebupirimiphos, teflubenzuron, tefluthrin, temephos, terbam, terbufos, tetrachlorvinphos, tetramisole, thenium, thiabendazole, thiacloprid, thiafenox, thiamethoxam thiodicarb, thiofanox, thiomethon, thionazin, thiophanate, thuringiensin, tralomethrin, triarathen, triazophos, triazuron, trichlorfon, trichlorfon, triclabendazole, triflumuron, trimethacarb, vamidothion, XMC, xylylcarb, zetamethrin, etc.

5. The method of claim 1, wherein the pesticidal composition further comprises a member selected from the group consisting of: Abamectin, Aversectin C, Doramectin, Emamectin, Eprinomectin, Ivermectin, Selamectin, Milbemectin, Milbemycin oxime, Moxidectin, Lepimectin, Nemadectin, Spinosad and Spinetoram.

6. The method of claim 1, wherein the pesticidal composition further comprises a member selected from the group consisting of neonicotinoids; cholineseterase inhibitors; sodium channel modulators; chitin synthesis inhibitors; ecdysone agonists and antagonists; lipid biosynthesis inhibitors; macrocyclic lactones; juvenile hormone mimics; ryanodine receptor ligands; octopamine receptor ligands; mitochondrial electron transport inhibitors; nereistoxin analogs; biological agents; and pesticidally acceptable salts thereof.

7. A method for inhibiting a pest GABA receptor, comprising contacting one or more pest GABA receptors with a pesticidal composition comprising a pesticidally-acceptable carrier and at least one GABA receptor modulator.

8. The method of claim 7, wherein the GABA receptor modulator is a member selected from the group consisting of: α-pinene, β-pinene; α-campholenic aldehyde; α-citronellol; α-iso-amyl-cinnamic (e.g., amyl cinnamic aldehyde); α-pinene oxide; α-cinnamic terpinene; α-terpineol (e.g., 1-methyl-4-isopropyl-1-cyclohexen-8-ol); λ-terpinene; achillea; aldehyde C16 (pure); alpha-phellandrene; amyl cinnamic aldehyde; amyl salicylate; anethole; anise; aniseed; anisic aldehyde; basil; bay; benzyl acetate; benzyl alcohol; bergamot (e.g., Monardia fistulosa, Monarda didyma, Citrus bergamia, Monarda punctata); bitter orange peel; black pepper; white pepper; borneol; calamus; camphor; cananga oil (e.g., java); cardamom; carnation (e.g., dianthus caryophyllus); carvacrol; carveol; cassia; castor; cedar (e.g., hinoki); cedarwood; chamomile; cineole; cinnamaldehyde; cinnamic alcohol; cinnamon; cis-pinane; citral (e.g., 3,7-dimethyl-2,6-octadienal); citronella; citronellal; citronellol dextro (e.g., 3,7-dimethyl-6-octen-1-ol); citronellol; citronellyl acetate; citronellyl nitrile; citrus unshiu; clary sage; clove (e.g., eugenia caryophyllus); clove bud; coriander; corn; cotton seed; 6-tert-butyl-m-cresol; d-dihydrocarvone; decyl aldehyde; diethyl phthalate; dihydroanethole; dihydrocarveol; dihydrocarvacrol; dihydrolinalool; dihydromyrcene; dihydromyrcenol; dihydromyrcenyl acetate; dihydroterpineol; dimethyl salicylate; dimethyloctanal; dimethyloctanol; dimethyloctanyl acetate; diphenyl oxide; dipropylene glycol; d-limonene; d-pulegone; estragole; ethyl vanillin (e.g., 3-ethoxy-4-hydrobenzaldehyde); eucalyptol (e.g., cineole); eucalyptus citriodora; eucalyptus globulus; eucalyptus; eugenol (e.g., 2-methoxy-4-allyl phenol); evening primrose; fenchol; fennel; Feniol™ (phenethyl alcohol and caprylyl glycol); fish oil; florazon (e.g., 4-ethyl-α,α-dimethyl-benzenepropanal); galaxolide; geraniol (e.g., 2-trans-3,7-dimethyl-2,6-octadien-8-ol); geraniol; geranium; geranyl acetate; geranyl nitrile; ginger; grapefruit; guaiacol; guaiacwood; gurjun balsam; heliotropin; herbanate (e.g., 3-(1-methyl-ethyl)bicyclo(2,2,1) hept-5-ene-2-carboxylic acid ethyl ester); hiba; hydroxycitronellal; i-carvone; i-methyl acetate; ionone; isobutyl quinoleine (e.g., 6-secondary butyl quinoline); isobornyl acetate; isobornyl methylether; isoeugenol; isolongifolene; jasmine; jojoba; juniper berry; lavender; lavandin; lemon grass; lemon; lime; limonene; linallol oxide; linallol; linalool; linalyl acetate; linseed; litsea cubeba; l-methyl acetate; longifolene; mandarin; mentha; menthane hydroperoxide; menthol crystals; menthol laevo (e.g., 5-methyl-2-isopropyl cyclohexanol); menthol; menthone laevo (e.g., 4-isopropyl-l-methyl cyclohexan-3-one); methyl anthranilate; methyl cedryl ketone; methyl chavicol; methyl hexyl ether; methyl ionone; mineral; mint; musk ambrette; musk ketone; musk xylol; mustard (also known as allylisothio-cyanate); myrcene; nerol; neryl acetate; nonyl aldehyde; nutmeg (e.g., myristica fragrans); orange (e.g., citrus aurantium dulcis); orris (e.g., iris florentina) root; para-cymene; para-hydroxy phenyl butanone crystals (e.g., 4-(4-hydroxyphenyl)-2-butanone); passion palmarosa oil (e.g., cymbopogon martini); patchouli (e.g., pogostemon cablin); p-cymene; pennyroyal oil; pepper; peppermint (e.g., mentha piperita); perillaldehyde; petitgrain (e.g., citrus aurantium amara); phenyl ethyl alcohol; phenyl ethyl propionate; phenyl ethyl-2-methylbutyrate; pimento berry; pimento leaf; pinane hydroperoxide; pinanol; pine ester; pine needle; pine; pinane; piperonal; piperonyl acetate; piperonyl alcohol; plinol; plinyl acetate; pseudo ionone; rhodinol; rhodinyl acetate; rosalin; rose; rosemary (e.g., rosmarinus officinalis); ryu; sage; sandalwood (e.g., santalum album); sandenol; sassafras; sesame; soybean; spearmint; spice; spike lavender; spirantol; starflower; tangerine; tea seed; tea tree; terpenoid; terpineol; terpinolene; terpinyl acetate; tert-butylcyclohexyl acetate; tetrahydrolinalool; tetrahydrolinalyl acetate; tetrahydromyrcenol; thulasi; thyme; thymol; tomato; trans-2-hexenol; trans-anethole and metabolites thereof; turmeric; turpentine; vanillin (e.g., 4-hydroxy-3-methoxy benzaldehyde); vetiver; vitalizair; white cedar; white grapefruit; and wintergreen (e.g., methyl salicylate).

9. The method of claim 7, wherein the pesticidal composition further comprises a member selected from the group consisting of: from a synergist, stabilizing substance, insecticide, pesticide, acaricide, plant nematicide, anthelmintic, anticoccidial, fungicide, bactericide, antiviral, arthropod attractant, arthropod repellent, arthropod pheromone, vertebrate attractant, vertebrate repellent, vertebrate pheromone, deodorant, flavoring agent, dye, trace element, and vitamin.

10. The method of claim 7, wherein the pesticidal composition further comprises a member selected from the group consisting of: acephate, acetamiprid, acrinathrin, alanycarb, albendazole, aldicarb, alphamethrin, amitraz, avermectins, azadirachtin, azinphos, azocyclotin, Bacillus thuringiensis, bendiocarb, benfuracarb, bensultap, benzoximate, bephenium, betacyfluthrin, bifenazate, bifenthrin, bistrifluoron, BPMC (2-sec-Butylphenyl Methylcarbamate), brofenprox, bromophos, brotianide, bufencarb, buprofezin, butamisole, butocarboxin, butylpyridaben, cadusafos, cambendazole, carbaryl, carbofuran, carbophenothion, carbosulfan, cartap, chloethocarb, chlorfenapyr, chloroethoxyfos, chlorofenvinphos, chlorofluazuron, chloromephos, chlorpyrifos, chromafenozide, cis-resmethrin, clocythrin, clofentezine, clorsulon, closantel, clothianidin, cyanophos, cycloprothrin, cyfluthrin, cyhalothrin, cyhexatin, cypermethrin, cyromazine, deltamethrin, demeton, demeton-S-methyl, diamphenethide, diaveridine, diazinon, dibromosalan, dichlofenthion, dichlorophen, dichlorvos, dicliphos, dicofol, dicrotophos, diethion, diethylcarbamazine, difenthiuron, diflubenzuron, dimethoate, dimethylvinphos, dimetridazole dinotefuran, dioxathion, disulfoton, edifenphos, endosulfan, epsiprantel, esfenvalerate, ethiofencarb, ethion, ethiprole, ethofenprox, ethoprofos, etoxazole, etrimphos, febantel, fenamiphos, fenbendazole, fenbutatin oxide, fenitrothion, fenobucarb, fenothiocarb, fenoxycarb, fenpropathrin, fenpropathrin, fenpyrad, fenpyroximate, fenthion, fenvalerate, fenzaquin, fipronil, flonicamid, fluazinam, fluazuron, flubendazole, flucycloxuron, flucythrinate, flufenoxuron, flufenprox, fluvalinate, fonophos, formothion, fosthiazate, fubfenprox, furathiocarb, gamma-cyhalothrin, haloxon, heptenophos, hexachlorophene, hexaflumuron, hexythiazox, imidacloprid, indoxacarb, iprobenfos, isazophos, isofenphos, isoprocarb, isoxathion, ivermectin, lambda-cyhalothrin, levamisole, lindane, lufenuron, malathion, mebendazole, mecarbam, mesulfenphos, metaldehyde, methacrifos, methamidophos, methidathion, methiocarb, methomyl, methoxyfenozide, methyridine, metolcarb, mevinphos, milbemectin, milbemycins, monocrotophos, morantel, naled, netobimin, niclopholan, niclosamide, nitenpyram, nitroxynil, omethoate, oxamyl, oxfendazole, oxibendazole, oxyclozanide, oxydemethon M, oxydeprofos, parathion A, parathion M, parathion, parbendazol, permethrin, phenothiazine, phenthoate, phorate, phosalone, phosmet, phosphamidon, phoxim, pirimicarb, pirimiphos, praziquantel, profenofos, promecarb, propaphos, propoxur, prothiofos, prothoate, pymetrozin, pyrachiophos, pyrantel, pyresmethrin, pyrethrum, pyridaben, pyridaphenthion, pyrimidifen, pyriproxifen, quinalphos, rafoxanide, rynaxypyr, salithion, sebufos, silafluofen, spirodiclofen, spirotetratmat, sulfotep, sulprofos, tebufenozid, tebufenpyrad, tebupirimiphos, teflubenzuron, tefluthrin, temephos, terbam, terbufos, tetrachlorvinphos, tetramisole, thenium, thiabendazole, thiacloprid, thiafenox, thiamethoxam thiodicarb, thiofanox, thiomethon, thionazin, thiophanate, thuringiensin, tralomethrin, triarathen, triazophos, triazuron, trichlorfon, trichlorfon, triclabendazole, triflumuron, trimethacarb, vamidothion, XMC, xylylcarb, zetamethrin, etc.

11. The method of claim 7, wherein the pesticidal composition further comprises a member selected from the group consisting of: Abamectin, Aversectin C, Doramectin, Emamectin, Eprinomectin, Ivermectin, Selamectin, Milbemectin, Milbemycin oxime, Moxidectin, Lepimectin, Nemadectin, Spinosad and Spinetoram.

12. The method of claim 7, wherein the pesticidal composition further comprises a member selected from the group consisting of neonicotinoids; cholinesterase inhibitors; sodium channel modulators; chitin synthesis inhibitors; ecdysone agonists and antagonists; lipid biosynthesis inhibitors; macrocyclic lactones; juvenile hormone mimics; ryanodine receptor ligands; octopamine receptor ligands; mitochondrial electron transport inhibitors; nereistoxin analogs; biological agents; and pesticidally acceptable salts thereof.

13. A method for controlling pests, comprising contacting a pest, animal, plant or inanimate object with a pesticidally-effective amount of a pesticidal composition comprising a pesticidally-acceptable carrier and at least one GABA receptor modulator.

14. The method of claim 13, wherein the GABA receptor modulator is a member selected from the group consisting of: α-pinene, β-pinene; α-campholenic aldehyde; α-citronellol; α-iso-amyl-cinnamic (e.g., amyl cinnamic aldehyde); α-pinene oxide; α-cinnamic terpinene; α-terpineol (e.g., 1-methyl-4-isopropyl-1-cyclohexen-8-ol); λ-terpinene; achillea; aldehyde C16 (pure); alpha-phellandrene; amyl cinnamic aldehyde; amyl salicylate; anethole; anise; aniseed; anisic aldehyde; basil; bay; benzyl acetate; benzyl alcohol; bergamot (e.g., Monardia fistulosa, Monarda didyma, Citrus bergamia, Monarda punctata); bitter orange peel; black pepper; white pepper; borneol; calamus; camphor; cananga oil (e.g., java); cardamom; carnation (e.g., dianthus caryophyllus); carvacrol; carveol; cassia; castor; cedar (e.g., hinoki); cedarwood; chamomile; cineole; cinnamaldehyde; cinnamic alcohol; cinnamon; cis-pinane; citral (e.g., 3,7-dimethyl-2,6-octadienal); citronella; citronellal; citronellol dextro (e.g., 3,7-dimethyl-6-octen-1-ol); citronellol; citronellyl acetate; citronellyl nitrile; citrus unshiu; clary sage; clove (e.g., eugenia caryophyllus); clove bud; coriander; corn; cotton seed; 6-tert-butyl-m-cresol; d-dihydrocarvone; decyl aldehyde; diethyl phthalate; dihydroanethole; dihydrocarveol; dihydrocarvacrol; dihydrolinalool; dihydromyrcene; dihydromyrcenol; dihydromyrcenyl acetate; dihydroterpineol; dimethyl salicylate; dimethyloctanal; dimethyloctanol; dimethyloctanyl acetate; diphenyl oxide; dipropylene glycol; d-limonene; d-pulegone; estragole; ethyl vanillin (e.g., 3-ethoxy-4-hydrobenzaldehyde); eucalyptol (e.g., cineole); eucalyptus citriodora; eucalyptus globulus; eucalyptus; eugenol (e.g., 2-methoxy-4-allyl phenol); evening primrose; fenchol; fennel; Feniol™ (phenethyl alcohol and caprylyl glycol); fish oil; florazon (e.g., 4-ethyl-α,α-dimethyl-benzenepropanal); galaxolide; geraniol (e.g., 2-trans-3,7-dimethyl-2,6-octadien-8-ol); geraniol; geranium; geranyl acetate; geranyl nitrile; ginger; grapefruit; guaiacol; guaiacwood; gurjun balsam; heliotropin; herbanate (e.g., 3-(1-methyl-ethyl)bicyclo(2,2,1) hept-5-ene-2-carboxylic acid ethyl ester); hiba; hydroxycitronellal; i-carvone; i-methyl acetate; ionone; isobutyl quinoleine (e.g., 6-secondary butyl quinoline); isobornyl acetate; isobornyl methylether; isoeugenol; isolongifolene; jasmine; jojoba; juniper berry; lavender; lavandin; lemon grass; lemon; lime; limonene; linallol oxide; linallol; linalool; linalyl acetate; linseed; litsea cubeba; l-methyl acetate; longifolene; mandarin; mentha; menthane hydroperoxide; menthol crystals; menthol laevo (e.g., 5-methyl-2-isopropyl cyclohexanol); menthol; menthone laevo (e.g., 4-isopropyl-l-methyl cyclohexan-3-one); methyl anthranilate; methyl cedryl ketone; methyl chavicol; methyl hexyl ether; methyl ionone; mineral; mint; musk ambrette; musk ketone; musk xylol; mustard (also known as allylisothio-cyanate); myrcene; nerol; neryl acetate; nonyl aldehyde; nutmeg (e.g., myristica fragrans); orange (e.g., citrus aurantium dulcis); orris (e.g., iris florentina) root; para-cymene; para-hydroxy phenyl butanone crystals (e.g., 4-(4-hydroxyphenyl)-2-butanone); passion palmarosa oil (e.g., cymbopogon martini); patchouli (e.g., pogostemon cablin); p-cymene; pennyroyal oil; pepper; peppermint (e.g., mentha piperita); perillaldehyde; petitgrain (e.g., citrus aurantium amara); phenyl ethyl alcohol; phenyl ethyl propionate; phenyl ethyl-2-methylbutyrate; pimento berry; pimento leaf; pinane hydroperoxide; pinanol; pine ester; pine needle; pine; pinene; piperonal; piperonyl acetate; piperonyl alcohol; plinol; plinyl acetate; pseudo ionone; rhodinol; rhodinyl acetate; rosalin; rose; rosemary (e.g., rosmarinus officinalis); ryu; sage; sandalwood (e.g., santalum album); sandenol; sassafras; sesame; soybean; spearmint; spice; spike lavender; spirantol; starflower; tangerine; tea seed; tea tree; terpenoid; terpineol; terpinolene; terpinyl acetate; tert-butylcyclohexyl acetate; tetrahydrolinalool; tetrahydrolinalyl acetate; tetrahydromyrcenol; thulasi; thyme; thymol; tomato; trans-2-hexenol; trans-anethole and metabolites thereof; turmeric; turpentine; vanillin (e.g., 4-hydroxy-3-methoxy benzaldehyde); vetiver; vitalizair; white cedar; white grapefruit; and wintergreen (e.g., methyl salicylate).

15. The method of claim 13, wherein the pesticidal composition further comprises a member selected from the group consisting of: from a synergist, stabilizing substance, insecticide, pesticide, acaricide, plant nematicide, anthelmintic, anticoccidial, fungicide, bactericide, antiviral, arthropod attractant, arthropod repellent, arthropod pheromone, vertebrate attractant, vertebrate repellent, vertebrate pheromone, deodorant, flavoring agent, dye, trace element, and vitamin.

16. The method of claim 13, wherein the pesticidal composition further comprises a member selected from the group consisting of: acephate, acetamiprid, acrinathrin, alanycarb, albendazole, aldicarb, alphamethrin, amitraz, avermectins, azadirachtin, azinphos, azocyclotin, Bacillus thuringiensis, bendiocarb, benfuracarb, bensultap, benzoximate, bephenium, betacyfluthrin, bifenazate, bifenthrin, bistrifluoron, BPMC (2-sec-Butylphenyl Methylcarbamate), brofenprox, bromophos, brotianide, bufencarb, buprofezin, butamisole, butocarboxin, butylpyridaben, cadusafos, cambendazole, carbaryl, carbofuran, carbophenothion, carbosulfan, cartap, chloethocarb, chlorfenapyr, chloroethoxyfos, chlorofenvinphos, chlorofluazuron, chloromephos, chlorpyrifos, chromafenozide, cis-resmethrin, clocythrin, clofentezine, clorsulon, closantel, clothianidin, cyanophos, cycloprothrin, cyfluthrin, cyhalothrin, cyhexatin, cypermethrin, cyromazine, deltamethrin, demeton, demeton-S-methyl, diamphenethide, diaveridine, diazinon, dibromosalan, dichlofenthion, dichlorophen, dichlorvos, dicliphos, dicofol, dicrotophos, diethion, diethylcarbamazine, difenthiuron, diflubenzuron, dimethoate, dimethylvinphos, dimetridazole dinotefuran, dioxathion, disulfoton, edifenphos, endosulfan, epsiprantel, esfenvalerate, ethiofencarb, ethion, ethiprole, ethofenprox, ethoprofos, etoxazole, etrimphos, febantel, fenamiphos, fenbendazole, fenbutatin oxide, fenitrothion, fenobucarb, fenothiocarb, fenoxycarb, fenpropathrin, fenpropathrin, fenpyrad, fenpyroximate, fenthion, fenvalerate, fenzaquin, fipronil, flonicamid, fluazinam, fluazuron, flubendazole, flucycloxuron, flucythrinate, flufenoxuron, flufenprox, fluvalinate, fonophos, formothion, fosthiazate, fubfenprox, furathiocarb, gamma-cyhalothrin, haloxon, heptenophos, hexachlorophene, hexaflumuron, hexythiazox, imidacloprid, indoxacarb, iprobenfos, isazophos, isofenphos, isoprocarb, isoxathion, ivermectin, lambda-cyhalothrin, levamisole, lindane, lufenuron, malathion, mebendazole, mecarbam, mesulfenphos, metaldehyde, methacrifos, methamidophos, methidathion, methiocarb, methomyl, methoxyfenozide, methyridine, metolcarb, mevinphos, milbemectin, milbemycins, monocrotophos, morantel, naled, netobimin, niclopholan, niclosamide, nitenpyram, nitroxynil, omethoate, oxamyl, oxfendazole, oxibendazole, oxyclozanide, oxydemethon M, oxydeprofos, parathion A, parathion M, parathion, parbendazol, permethrin, phenothiazine, phenthoate, phorate, phosalone, phosmet, phosphamidon, phoxim, pirimicarb, pirimiphos, praziquantel, profenofos, promecarb, propaphos, propoxur, prothiofos, prothoate, pymetrozin, pyrachlophos, pyrantel, pyresmethrin, pyrethrum, pyridaben, pyridaphenthion, pyrimidifen, pyriproxifen, quinalphos, rafoxanide, rynaxypyr, salithion, sebufos, silafluofen, spirodiclofen, spirotetratmat, sulfotep, sulprofos, tebufenozid, tebufenpyrad, tebupirimiphos, teflubenzuron, tefluthrin, temephos, terbam, terbufos, tetrachlorvinphos, tetramisole, thenium, thiabendazole, thiacloprid, thiafenox, thiamethoxam thiodicarb, thiofanox, thiomethon, thionazin, thiophanate, thuringiensin, tralomethrin, triarathen, triazophos, triazuron, trichlorfon, trichlorfon, triclabendazole, triflumuron, trimethacarb, vamidothion, XMC, xylylcarb, zetamethrin, etc.

17. The method of claim 13, wherein the pesticidal composition further comprises a member selected from the group consisting of: Abamectin, Aversectin C, Doramectin, Emamectin, Eprinomectin, Ivermectin, Selamectin, Milbemectin, Milbemycin oxime, Moxidectin, Lepimectin, Nemadectin, Spinosad and Spinetoram.

18. The method of claim 13, wherein the pesticidal composition further comprises a member selected from the group consisting of neonicotinoids; cholineseterase inhibitors; sodium channel modulators; chitin synthesis inhibitors; ecdysone agonists and antagonists; lipid biosynthesis inhibitors; macrocyclic lactones; juvenile hormone mimics; ryanodine receptor ligands; octopamine receptor ligands; mitochondrial electron transport inhibitors; nereistoxin analogs; biological agents; and pesticidally acceptable salts thereof.
